(19) United States
(12) Patent Application Publication
(10) Pub. No.: US 2025/0389937 A1
(43) Pub. Date: Dec. 25, 2025

(54) WIDE-ANGLE LENS ASSEMBLY

(71) Applicant: Asia Optical Co., Inc., Taichung (TW)

(72) Inventor: Po-Yu Chen, Taichung (TW)

(21) Appl. No.: 18/985,343

(22) Filed: Dec. 18, 2024

(30) Foreign Application Priority Data
Jun. 20, 2024 (CN) 202410803982.1

(51) Int. Cl. G02B 13/06; G02B 9/64; G02B 13/00

(52) U.S. Cl. CPC G02B 13/06; G02B 9/64; G02B 13/0045

(57) ABSTRACT

A wide-angle lens assembly includes a first lens, a second lens, a third lens, a fourth lens, a fifth lens, a sixth lens, a seventh lens, and an eighth lens. The first lens is with negative refractive power and includes a concave surface facing an image side. The second lens is with refractive power. The third lens is with refractive power. The fourth lens is with positive refractive power and includes a convex surface facing the image side. The fifth lens is with positive refractive power. The sixth lens is with refractive power. The seventh lens is with refractive power. The eighth lens is with positive refractive power and includes a convex surface facing an object side. The first, second, third, fourth, fifth, sixth, seventh, and eighth lenses are arranged in order from the object side to the image side along an optical axis.

### BACKGROUND OF THE INVENTION

### Field of the Invention

The present invention relates to a wide-angle lens assembly.

### Description of the Related Art

The current development trend of a wide-angle lens assembly is toward large field of view. Additionally, the wide-angle lens assembly is developed to have high resolution and resisted environment temperature change in accordance with different application requirements. However, the known wide-angle lens assembly can't satisfy such requirements. Therefore, the wide-angle lens assembly needs a new structure in order to meet the requirements of large field of view, high resolution, and resisted environment temperature change at the same time.

### BRIEF SUMMARY OF THE INVENTION

The invention provides a wide-angle lens assembly to solve the above problems. The wide-angle lens assembly of the invention is provided with characteristics of an increased field of view, an increased resolution, a resisted environment temperature change, and still has a good optical performance.

The wide-angle lens assembly in accordance with an exemplary embodiment of the invention includes a first lens, a second lens, a third lens, a fourth lens, a fifth lens, a sixth lens, a seventh lens, and an eighth lens. The first lens is with negative refractive power and includes a concave surface facing an image side. The second lens is with refractive power. The third lens is with refractive power. The fourth lens is with positive refractive power and includes a convex surface facing the image side. The fifth lens is with positive refractive power. The sixth lens is with refractive power. The seventh lens is with refractive power. The eighth lens is with positive refractive power and includes a convex surface facing an object side. The first lens, the second lens, the third lens, the fourth lens, the fifth lens, the sixth lens, the seventh lens, and the eighth lens are arranged in order from the object side to the image side along an optical axis. The wide-angle lens assembly satisfies at least one of the following conditions: 4.86≤(R51-R52)/T5≤44.77; −55.77≤ (R71-R71)/T7≤91.31; wherein R51 is a radius of curvature of an object side surface of the fifth lens, R52 is a radius of curvature of an image side surface of the fifth lens, R71 is a radius of curvature of an object side surface of the seventh lens, R72 is a radius of curvature of an image side surface of the seventh lens, T5 is an interval from the object side surface of the fifth lens to the image side surface of the fifth lens along the optical axis, and T7 is an interval from the object side surface of the seventh lens to the image side surface of the seventh lens along the optical axis. The wide-angle lens assembly further satisfies at least one of the following conditions: −6.85≤f1/f≤−1.21; 17.91 degrees/mm≤HFOV/f≤121.68 degrees/mm; −35.56 degrees/mm≤ HFOV/f3≤11.08 degrees/mm; 3.47 degrees/mm≤HFOV/f4≤29.94 degrees/mm; 6.01 degrees/mm≤HFOV/f5≤40.87 degrees/mm; −66.89 degrees/mm≤HFOV/f7≤ 38.23 degrees/mm; 1.68 degrees/mm≤HFOV/f8≤40.21 degrees/mm; 5.32≤TTL/d45≤63.18; 3.69≤TTL/BFL≤7.13; wherein f is an effective focal length of the wide-angle lens assembly, f1 is an effective focal length of the first lens, f3 is an effective focal length of the third lens, f4 is an effective focal length of the fourth lens, f5 is an effective focal length of the fifth lens, f7 is an effective focal length of the seventh lens, f8 is an effective focal length of the eighth lens, HFOV is a full horizontal field of view of the wide-angle lens assembly, TTL is an interval from an object side surface of the first lens to an image plane along the optical axis, BFL is an interval from an image side surface of the eighth lens to the image plane along the optical axis, and d45 is an air interval from an image side surface of the fourth lens to the object side surface of the fifth lens along the optical axis. A wide-angle lens assembly of the present invention can achieve basic operation when the wide-angle lens assembly satisfies the above features and at least one of the above conditions, and does not need other additional features or conditions.

In another exemplary embodiment, the first lens is a meniscus lens and further includes a convex surface facing the object side; the second lens is with negative refractive power; the fourth lens is a biconvex lens and further includes another convex surface facing the object side; the fifth lens is a biconvex lens and includes a convex surface facing the object side and another convex surface facing the image side; and the eighth lens is a biconvex lens and further includes another convex surface facing the image side.

In yet another exemplary embodiment, the second lens is a meniscus lens and includes a convex surface facing the object side and a concave surface facing the image side; and the third lens is with negative refractive power and includes a concave surface facing the object side.

In another exemplary embodiment, the sixth lens is with positive refractive power and the seventh lens is with negative refractive power.

In yet another exemplary embodiment, the sixth lens is a biconvex lens and includes a convex surface facing the object side and another convex surface facing the image side; and the seventh lens is a biconcave lens and includes a concave surface facing the object side and another concave surface facing the image side.

In another exemplary embodiment, the wide-angle lens assembly satisfies at least one of the following conditions: 0.3≤| f2/f|≤8.5; 0.2≤| f4/f|≤8.1; 0.3≤| f5/f|≤5.7; 0.3≤| f8/f|≤10.2; wherein f is the effective focal length of the wide-angle lens assembly, f2 is an effective focal length of the second lens, f4 is the effective focal length of the fourth lens, f5 is the effective focal length of the fifth lens, and f8 is the effective focal length of the eighth lens.

In yet another exemplary embodiment, the sixth lens is a meniscus lens and includes a convex surface facing the object side and a concave surface facing the image side; and the seventh lens is a meniscus lens and includes a convex surface facing the object side and a concave surface facing the image side.

In another exemplary embodiment, the sixth lens and the seventh lens are cemented.

In yet another exemplary embodiment, the third lens includes a convex surface or a concave surface facing the image side.

In another exemplary embodiment, the seventh lens is a biconvex lens with positive refractive power and includes a convex surface facing the object side and another convex surface facing the image side, or the sixth lens and the seventh lens are cemented.

In yet another exemplary embodiment, the second lens is a meniscus lens and includes a concave surface facing the object side and a convex surface facing the image side; the third lens is a meniscus lens with positive refractive power and further includes a convex surface facing the object side; and the sixth lens is a meniscus lens with negative refractive power and includes a convex surface facing the object side and a concave surface facing the image side.

In another exemplary embodiment, the second lens is a biconcave lens and includes a concave surface facing the object side and another concave surface facing the image side; the third lens is a biconvex lens with positive refractive power and further includes another convex surface facing the object side; the seventh lens is a meniscus lens with positive refractive power and includes a concave surface facing the object side and a convex surface facing the image side; and the fifth lens and the sixth lens are cemented.

In yet another exemplary embodiment, the sixth lens is a biconcave lens with negative refractive power and includes a concave surface facing the object side and another concave surface facing the image side.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIGS. 1, 9, 10, 18, 19, 20, 28, 36, 44 are lens layout diagrams of wide-angle lens assemblies in accordance with a first, a second, a third, a fourth, a fifth, a sixth, a seventh, an eighth, and a ninth embodiments of the invention, respectively;

FIGS. 2, 3, 4, 5, 6, 7, 8 depict a longitudinal aberration diagram, a field curvature diagram, a distortion diagram, a lateral color diagram, a relative illumination diagram, a modulation transfer function diagram, and a through focus modulation transfer function diagram of the wide-angle lens assembly in accordance with the first embodiment of the invention, respectively;

FIGS. 11, 12, 13, 14, 15, 16, 17 depict a longitudinal aberration diagram, a field curvature diagram, a distortion diagram, a lateral color diagram, a relative illumination diagram, a modulation transfer function diagram, and a through focus modulation transfer function diagram of the wide-angle lens assembly in accordance with the third embodiment of the invention, respectively;

FIGS. 21, 22, 23, 24, 25, 26, 27 depict a longitudinal aberration diagram, a field curvature diagram, a distortion diagram, a lateral color diagram, a relative illumination diagram, a modulation transfer function diagram, and a through focus modulation transfer function diagram of the wide-angle lens assembly in accordance with the sixth embodiment of the invention, respectively;

FIGS. 29, 30, 31, 32, 33, 34, 35 depict a longitudinal aberration diagram, a field curvature diagram, a distortion diagram, a lateral color diagram, a relative illumination diagram, a modulation transfer function diagram, and a through focus modulation transfer function diagram of the wide-angle lens assembly in accordance with the seventh embodiment of the invention, respectively; and

FIGS. 37, 38, 39, 40, 41, 42, 43 depict a longitudinal aberration diagram, a field curvature diagram, a distortion diagram, a lateral color diagram, a relative illumination diagram, a modulation transfer function diagram, and a through focus modulation transfer function diagram of the wide-angle lens assembly in accordance with the eighth embodiment of the invention, respectively.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides a wide-angle lens assembly including a first lens, a second lens, a third lens, a fourth lens, a fifth lens, a sixth lens, a seventh lens, and an eighth lens. The first lens is with negative refractive power and includes a concave surface facing an image side. The second lens is with refractive power. The third lens is with refractive power. The fourth lens is with positive refractive power and includes a convex surface facing the image side. The fifth lens is with positive refractive power. The sixth lens is with refractive power. The seventh lens is with refractive power. The eighth lens is with positive refractive power and includes a convex surface facing an object side. The first lens, the second lens, the third lens, the fourth lens, the fifth lens, the sixth lens, the seventh lens, and the eighth lens are arranged in order from the object side to the image side along an optical axis. The wide-angle lens assembly satisfies at least one of the following conditions: 4.86≤ (R51-R52)/T5≤44.77; −55.77≤(R71-R71)/T7≤91.31; wherein R51 is a radius of curvature of an object side surface of the fifth lens, R52 is a radius of curvature of an image side surface of the fifth lens, R71 is a radius of curvature of an object side surface of the seventh lens, R72 is a radius of curvature of an image side surface of the seventh lens, T5 is an interval from the object side surface of the fifth lens to the image side surface of the fifth lens along the optical axis, and T7 is an interval from the object side surface of the seventh lens to the image side surface of the seventh lens along the optical axis. The wide-angle lens assembly further satisfies at least one of the following conditions: −6.85≤f1/f≤−1.21; 17.91 degrees/mm≤HFOV/f≤121.68 degrees/mm; −35.56 degrees/mm≤HFOV/f3≤11.08 degrees/mm; 3.47 degrees/mm≤HFOV/f4≤29.94 degrees/mm; 6.01 degrees/mm≤HFOV/f5≤40.87 degrees/mm; −66.89 degrees/mm≤HFOV/f7≤38.23 degrees/mm; 1.68 degrees/mm≤HFOV/f8≤ 40.21 degrees/mm; 5.32≤TTL/d45≤63.18; 3.69≤TTL/BFL≤7.13; wherein f is an effective focal length of the wide-angle lens assembly, f1 is an effective focal length of the first lens, f3 is an effective focal length of the third lens, f4 is an effective focal length of the fourth lens, f5 is an effective focal length of the fifth lens, f7 is an effective focal length of the seventh lens, f8 is an effective focal length of the eighth lens, HFOV is a full horizontal field of view of the wide-angle lens assembly, TTL is an interval from an object side surface of the first lens to an image plane along the optical axis, BFL is an interval from an image side surface of the eighth lens to the image plane along the optical axis, and d45 is an air interval from an image side surface of the fourth lens to the object side surface of the fifth lens along the optical axis. A wide-angle lens assembly of the present invention is a preferred embodiment of the present invention when the wide-angle lens assembly satisfies the above features and at least one of the above conditions.

Referring to Table 1, Table 2, Table 4, Table 5, Table 7, Table 8, Table 10, Table 11, Table 13, Table 14, Table 16, Table 17, Table 19, Table 20, Table 22, and Table 24, wherein Table 1, Table 4, Table 7, Table 10, Table 13, Table 16, Table 19, Table 22, and Table 24 show optical specification in accordance with a first, a second, a third, a fourth, a fifth, a sixth, a seventh, an eighth, and a ninth embodiments of the invention, respectively, and Table 2, Table 5, Table 8, Table 11, Table 14, Table 17, and Table 20 show aspheric coefficients of each aspheric lens in Table 1, Table 4, Table 7, Table 10, Table 13, Table 16, and Table 19, respectively. The aspheric surface sag z of each aspheric lens in the following embodiments can be calculated by the following formula: z=ch²/{1+ [1-(k+1) c²h²] ½}+Ah⁴+Bh⁶+Ch⁸+Dh¹⁰+Eh¹²+Fh¹⁴ where c is curvature, h is the vertical distance from the lens surface to the optical axis, k is conic constant, A, B, C, D, E, and F are aspheric coefficients, and the value of the aspheric coefficient A, B, C, D, E, and F are presented in scientific notation, such as 2E-03 for 2×10⁻³.

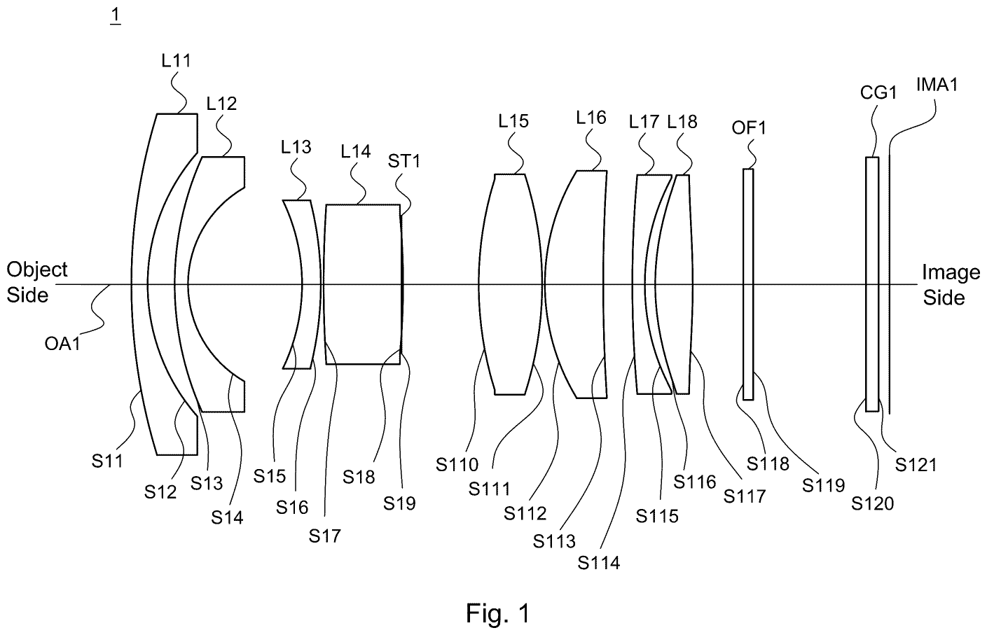

FIGS. 1, 9, 10, 18, 19, 20, 28, 36, 44 are lens layout diagrams of wide-angle lens assemblies in accordance with a first, a second, a third, a fourth, a fifth, a sixth, a seventh, an eighth, and a ninth embodiments of the invention, respectively.

The first lenses L11, L21, L31, L41, L51, L61, L71, L81, L91 are meniscus lenses with negative refractive power, wherein the object side surfaces S11, S21, S31, S41, S51, S61, S71, S81, S91 are convex surfaces, the image side surfaces S12, S22, S32, S42, S52, S62, S72, S82, S92 are concave surfaces, and both of the object side surfaces S11, S21, S31, S41, S51, S61, S71, S81, S91 and image side surfaces S12, S22, S32, S42, S52, S62, S72, S82, S92 are spherical surfaces.

The second lenses L12, L22, L32, L42, L52, L62, L72, L82, L92 are with negative refractive power, wherein both of the object side surfaces S13, S23, S33, S43, S53, S63, S73, S83, S93 and image side surfaces S14, S24, S34, S44, S54, S64, S74, S84, S94 are spherical surfaces.

The third lenses L13, L23, L33, L43, L53, L63, L73, L83, L93 are with refractive power.

The fourth lenses L14, L24, L34, L44, L54, L64, L74, L84, L94 are biconvex lenses with positive refractive power, wherein the object side surfaces S17, S27, S37, S47, S57, S67, S77, S87, S97 are convex surfaces and the image side surfaces S18, S28, S38, S48, S58, S68, S78, S88, S98 are convex surfaces.

The fifth lenses L15, L25, L35, L45, L55, L65, L75, L85, L95 are biconvex lenses with positive refractive power, wherein the object side surfaces S110, S210, S310, S410, S510, S610, S710, S810, S910 are convex surfaces and the image side surfaces S111, S211, S311, S411, S511, S611, S711, S811, S911 are convex surfaces.

The sixth lenses L16, L26, L36, L46, L56, L66, L76, L86, L96 are with refractive power, wherein both of the object side surfaces S112, S212, S312, S412, S512, S612, S712, S811, S911 and image side surfaces S113, S213, S313, S413, S513, S613, S713, S812, S912 are spherical surfaces.

The seventh lenses L17, L27, L37, L47, L57, L67, L77, L87, L97 are with refractive power, wherein both of the object side surfaces S114, S214, S313, S413, S513, S613, S713, S813, S913 and image side surfaces S115, S215, S314, S414, S514, S614, S714, S814, S914 are spherical surfaces.

The eighth lenses L18, L28, L38, L48, L58, L68, L78, L88, L98 are biconvex lenses with positive refractive power, wherein the object side surfaces S116, S216, S315, S415, S515, S615, S715, S815, S915 are convex surfaces and the image side surfaces S117, S217, S316, S416, S516, S616, S716, S816, S916 are convex surfaces.

In addition, the wide-angle lens assemblies 1, 2, 3, 4, 5, 6, 7, 8, and 9 satisfy at least one of the following conditions (1)-(15):

$$0.3 \leq \vert f 2 / f \vert \leq 8.5 ; \qquad ( 1 )$$

$$0.2 \leq \vert f 4 / f \vert \leq 8.1 ; \qquad ( 2 )$$

$$0.3 \leq \vert f 5 / f \vert \leq 5.7 ; \qquad ( 3 )$$

$$0.3 \leq \vert f 8 / f \vert \leq 10.2 ; \qquad ( 4 )$$

$$4.86 \leq ( R 51 - R 52 ) / T 5 \leq 44.77 ; \qquad ( 5 )$$

$$- 55.77 \leq ( R 71 - R 71 ) / T 7 \leq 91.31 ; \qquad ( 6 )$$

$$- 6.85 \leq f 1 / f \leq - 1.21 ; \qquad ( 7 )$$

$$17.91 degrees / mm \leq HFOV / f \leq 121.68 degrees / mm ; \qquad ( 8 )$$

$$- 35.56 degrees / mm \leq HFOV / f 3 \leq 11.08 degrees / mm ; \qquad ( 9 )$$

$$3.47 degrees / mm \leq HFOV / f 4 \leq 29.94 degrees / mm ; \qquad ( 10 )$$

$$6.01 degrees / mm \leq HFOV / f 5 \leq 40.87 degrees / mm ; \qquad ( 11 )$$

$$- 66.89 degrees / mm \leq HFOV / f 7 \leq 38.23 degrees / mm ; \qquad ( 12 )$$

$$1.68 degrees / mm \leq HFOV / f 8 \leq 40.21 degrees / mm ; \qquad ( 13 )$$

$$5.32 \leq TTL / d 45 \leq 63.18 ; \qquad ( 14 )$$

$$3.69 \leq TTL / BFL \leq 7.13 ; \qquad ( 15 )$$

wherein the parameters in the first to ninth embodiments are defined as follows: f is an effective focal length of wide-angle lens assemblies 1, 2, 3, 4, 5, 6, 7, 8, 9; f1 is an effective focal length of the first lenses L11, L21, L31, L41, L51, L61, L71, L81, L91; f2 is an effective focal length of the second lenses L12, L22, L32, L42, L52, L62, L72, L82, L92; f3 is an effective focal length of the third lenses L13, L23, L33, L43, L53, L63, L73, L83, L93; f4 is an effective focal length of the fourth lenses L14, L24, L34, L44, L54, L64, L74, L84, L94; f5 is an effective focal length of the fifth lenses L15, L25, L35, L45, L55, L65, L75, L85, L95; f7 is an effective focal length of the seventh lenses L17, L27, L37, L47, L57, L67, L77, L87, L97; f8 is an effective focal length of the eighth lenses L18, L28, L38, L48, L58, L68, L78, L88, L98; HFOV is a full horizontal field of view of the wide-angle lens assemblies 1, 2, 3, 4, 5, 6, 7, 8, 9; TTL is an interval from the object side surfaces S11, S21, S31, S41, S51, S61, S71, S81, S91 of the first lenses L11, L21, L31, L41, L51, L61, L71, L81, L91 to the image planes IMA1, IMA2, IMA3, IMA4, IMA5, IMA6, IMA7, IMA8, IMA9 along the optical axes OA1, OA2, OA3, OA4, OA5, OA6, OA7, OA8, OA9; BFL is an interval from the image side surfaces S117, S217, S316, S416, S516, S616, S716, S816, S916 of the eighth lenses L18, L28, L38, L48, L58, L68, L78, L88, L98 to the image planes IMA1, IMA2, IMA3, IMA4, IMA5, IMA6, IMA7, IMA8, IMA9 along the optical axes OA1, OA2, OA3, OA4, OA5, OA6, OA7, OA8, OA9; R51 is a radius of curvature of the object side surfaces S110, S210, S310, S410, S510, S610, S710, S810, S910 of the fifth lenses L15, L25, L35, L45, L55, L65, L75, L85, L95; R52 is a radius of curvature of the image side surfaces S111, S211, S311, S411, S511, S611, S711, S811, S911 of the fifth lenses L15, L25, L35, L45, L55, L65, L75, L85, L95; R71 is a radius of curvature of the object side surfaces S114, S214, S313, S413, S513, S613, S713, S813, S913 of the seventh lenses L17, L27, L37, L47, L57, L67, L77, L87, L97; R72 is a radius of curvature of the image side surfaces S115, S215, S314, S414, S514, S614, S714, S814, S914 of the seventh lenses L17, L27, L37, L47, L57, L67, L77, L87, L97; T5 is an interval from the object side surfaces S110, S210, S310, S410, S510, S610, S710, S810, S910 of the fifth lenses L15, L25, L35, L45, L55, L65, L75, L85, L95 to the image side surfaces S111, S211, S311, S411, S511, S611, S711, S811, S911 of the fifth lenses L15, L25, L35, L45, L55, L65, L75, L85, L95 along the optical axes OA1, OA2, OA3, OA4, OA5, OA6, OA7, OA8, OA9; T7 is an interval from the object side surfaces S114, S214, S313, S413, S513, S613, S713, S813, S913 of the seventh lenses L17, L27, L37, L47, L57, L67, L77, L87, L97 to the image side surfaces S115, S215, S314, S414, S514, S614, S714, S814, S914 of the seventh lenses L17, L27, L37, L47, L57, L67, L77, L87, L97 along the optical axes OA1, OA2, OA3, OA4, OA5, OA6, OA7, OA8, OA9; and d45 is an air interval from the image side surfaces S18, S28, S38, S48, S58, S68, S78, S88, S98 of the fourth lenses L14, L24, L34, L44, L54, L64, L74, L84, L94 to the object side surfaces S110, S210, S310, S410, S510, S610, S710, S810, S910 of the fifth lenses L15, L25, L35, L45, L55, L65, L75, L85, L95 along the optical axes OA1, OA2, OA3, OA4, OA5, OA6, OA7, OA8, OA9. Making the wide-angle lens assemblies 1, 2, 3, 4, 5, 6, 7, 8, 9 effectively increasing the field of view, effectively increasing the resolution, effectively resisting the environment temperature change, and effectively correcting aberration.

When the condition (5): 4.86≤(R51-R52)/T5≤44.77 is satisfied, the aberration can be effectively corrected and the resolution can be effectively increased. When the condition (6): −55.77≤(R71-R71)/T7≤91.31 is satisfied, the aberration can be effectively corrected and the resolution can be effectively increased. When the condition (7): −6.85≤f1/f≤−1.21 is satisfied, the aberration can be effectively corrected, the resolution can be effectively increased, the field curvature can be effectively decreased, and the manufacturing yield of the lens can be effectively increased. When the condition (8): 17.91 degrees/mm≤HFOV/f≤121.68 degrees/mm is satisfied, the aberration can be effectively corrected, the resolution can be effectively increased, the field curvature can be effectively decreased, and the manufacturing yield of the lens can be effectively increased. When the condition (9): −35.56 degrees/mm≤HFOV/f3≤11.08 degrees/mm is satisfied, the aberration can be effectively corrected, the resolution can be effectively increased, the field curvature can be effectively decreased, and the manufacturing yield of the lens can be effectively increased. When the condition (10): 3.47 degrees/mm≤HFOV/f4≤ 29.94 degrees/mm is satisfied, the aberration can be effectively corrected, the resolution can be effectively increased, the field curvature can be effectively decreased, and the manufacturing yield of the lens can be effectively increased. When the condition (11): 6.01 degrees/mm≤HFOV/f5≤40.87 degrees/mm is satisfied, the aberration can be effectively corrected, the resolution can be effectively increased, the field curvature can be effectively decreased, and the manufacturing yield of the lens can be effectively increased. When the condition (12): −66.89 degrees/mm≤HFOV/f7≤38.23 degrees/mm is satisfied, the aberration can be effectively corrected, the resolution can be effectively increased, the field curvature can be effectively decreased, and the manufacturing yield of the lens can be effectively increased. When the condition (13): 1.68 degrees/mm≤HFOV/f8≤ 40.21 degrees/mm is satisfied, the aberration can be effectively corrected, the resolution can be effectively increased, the field curvature can be effectively decreased, and the manufacturing yield of the lens can be effectively increased. When the condition (14): 5.32≤TTL/d45≤63.18 is satisfied, the aberration can be effectively corrected, the resolution can be effectively increased, the field curvature can be effectively decreased, and the manufacturing yield of the lens can be effectively increased. When the condition (15): 3.69≤TTL/BFL≤7.13 is satisfied, the aberration can be effectively corrected, the resolution can be effectively increased, the field curvature can be effectively decreased, and the manufacturing yield of the lens can be effectively increased.

A detailed description of a wide-angle lens assembly in accordance with a first embodiment of the invention is as follows. Referring to FIG. 1, the wide-angle lens assembly 1 includes a first lens L11, a second lens L12, a third lens L13, a fourth lens L14, a stop ST1, a fifth lens L15, a sixth lens L16, a seventh lens L17, an eighth lens L18, an optical filter OF1, and a cover glass CG1, all of which are arranged in order from an object side to an image side along an optical axis OA1. In operation, the light from the object side is imaged on an image plane IMA1.

According to the foregoing, wherein: the second lens L12 is a meniscus lens, wherein the object side surface S13 is a convex surface and the image side surface S14 is a concave surface; the third lens L13 is a meniscus lens with negative refractive power, wherein the object side surface S15 is a concave surface, the image side surface S16 is a convex surface, and both of the object side surface S15 and image side surface S16 are spherical surfaces; both of the object side surface S17 and image side surface S18 of the fourth lens L14 are spherical surfaces; both of the object side surface S110 and image side surface S111 of the fifth lens L15 are spherical surfaces; the sixth lens L16 is a meniscus lens with positive refractive power, wherein the object side surface S112 is a convex surface and the image side surface S113 is a concave surface; the seventh lens L17 is a meniscus lens with negative refractive power, wherein the object side surface S114 is a convex surface and the image side surface S115 is a concave surface; both of the object side surface S116 and image side surface S117 of the eighth lens L18 are aspheric surfaces; both of the object side surface S118 and image side surface S119 of the optical filter OF1 are plane surfaces; both of the object side surface S120 and image side surface S121 of the cover glass CG1 are plane surfaces; and with the above design of the lenses, stop ST1, and at least one of the conditions (1)-(15) satisfied, the wide-angle lens assembly 1 can have an effective increased field of view, an effective increased resolution, an effective resisted environment temperature change, and an effective corrected aberration. When the wide-angle lens assembly of the present invention only satisfies condition (1) or condition (2); and the refractive surface shape in independent claim; the basic operation requirements can be met.

Table 1 shows the optical specification of the wide-angle lens assembly 1 in FIG. 1.

TABLE 1
Effective Focal Length = 4.26 mm F-number = 1.80
Total Lens Length = 30.04 mm Field of View = 120.00 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S11 | 23.18 | 0.64 | 1.76 | 52.33 | −16.15 | L11 |
| S12 | 7.91 | 1.10 | | | | |
| S13 | 12.62 | 0.49 | 1.59 | 68.34 | −11.65 | L12 |
| S14 | 4.41 | 4.52 | | | | |
| S15 | −7.68 | 0.75 | 1.46 | 90.27 | −41.16 | L13 |
| S16 | −13.38 | 0.11 | | | | |
| S17 | 48.53 | 3.15 | 1.72 | 29.51 | 25.64 | L14 |
| S18 | −29.09 | −0.07 | | | | |
| S19 | ∞ | 3.06 | | | | ST1 |
| S110 | 14.06 | 2.52 | 1.46 | 90.27 | 15.78 | L15 |
| S111 | −13.99 | 0.10 | | | | |
| S112 | 8.63 | 2.31 | 1.59 | 67.33 | 16.42 | L16 |
| S113 | 66.53 | 1.17 | | | | |
| S114 | 50.34 | 0.49 | 1.96 | 17.47 | −11.30 | L17 |
| S115 | 8.95 | 0.41 | | | | |
| S116 | 9.91 | 1.49 | 1.77 | 47.17 | 10.05 | L18 |
| S117 | −34.38 | 2.00 | | | | |
| S118 | ∞ | 0.40 | 1.52 | 64.00 | | OF1 |
| S119 | ∞ | 4.47 | | | | |
| S120 | ∞ | 0.50 | 1.52 | 64.00 | | CG1 |
| S121 | ∞ | 0.44 | | | | |

In the first embodiment, the conic constant k and the aspheric coefficients A, B, C, D, E, F of each aspheric lens are shown in Table 2.

TABLE 2

| Surface | | | | | | | |
|---|---|---|---|---|---|---|---|
| Number | k | A | B | C | D | E | F |
| S116 | 0 | −0.0004 | 7.47E−06 | −5.25E−07 | 0 | 0 | 0 |
| S117 | 11.7818 | 0.0004 | 8.43E−06 | −2.98E−07 | 0 | 0 | 0 |

Table 3 shows the parameters and condition values for conditions (1)-(15) in accordance with the first embodiment of the invention. It can be seen from Table 3 that the wide-angle lens assembly 1 of the first embodiment satisfies the conditions (1)-(15).

TABLE 3

| | | | | | |
|---|---|---|---|---|---|
| BFL | 7.80 mm | T5 | 2.52 mm | T7 | 0.49 mm |
| d45 | 2.99 mm | | | | |
| \|f2/f\| | 2.73 | \|f4/f\| | 6.02 | \|f5/f\| | 3.70 |
| \|f8/f\| | 2.36 | (R51 − R52)/T5 | 11.13 | (R71 − R72)/T7 | 84.62 |
| f1/f | −3.79 | HFOV/f | 28.17 degrees/ | HFOV/f3 | −2.92 degrees/ |
| | | | mm | | mm |
| HFOV/f4 | 4.68 degrees/ | HFOV/f5 | 7.61 degrees/ | HFOV/f7 | −10.62 degrees/ |
| | mm | | mm | | mm |
| HFOV/f8 | 11.94 degrees/ | TTL/d45 | 10.04 | TTL/BFL | 3.85 |
| | mm | | | | |

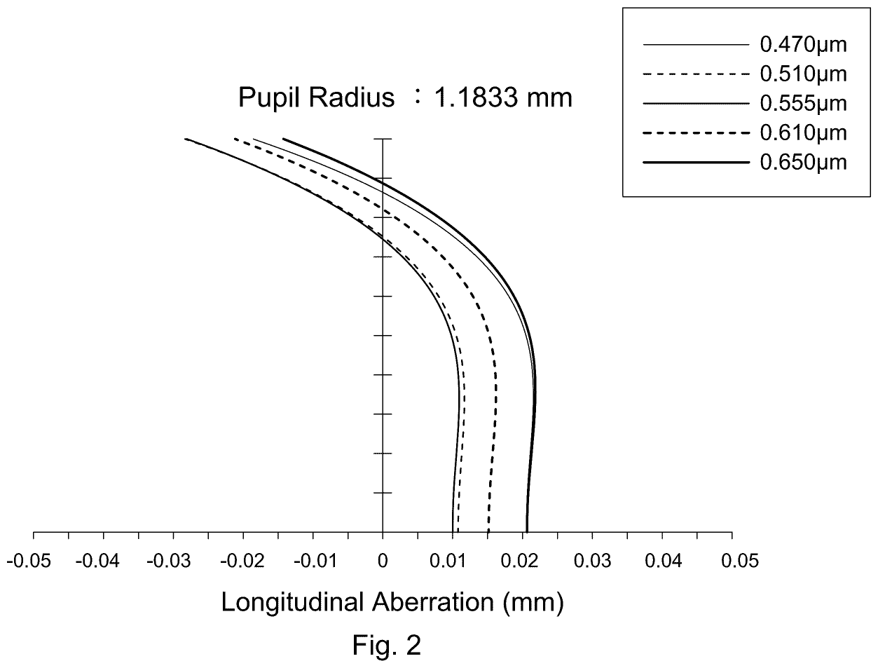

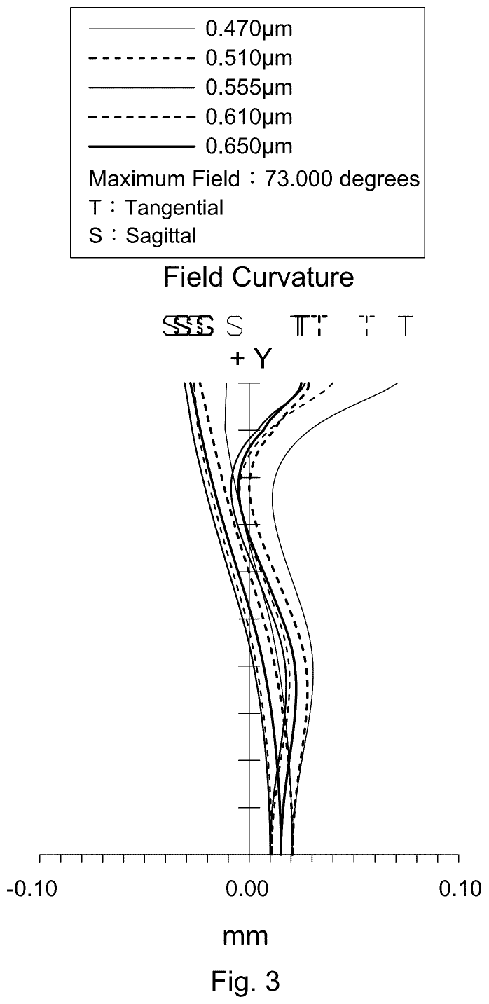

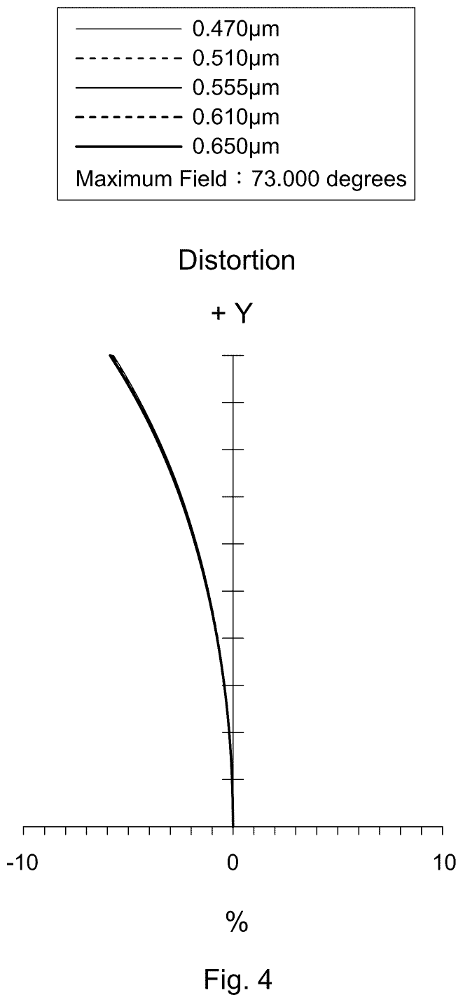

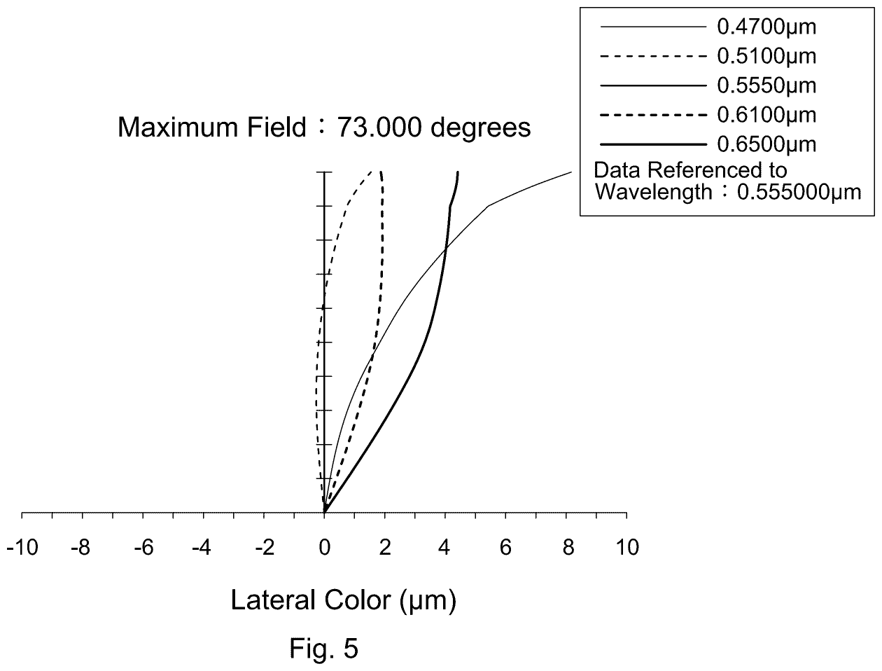

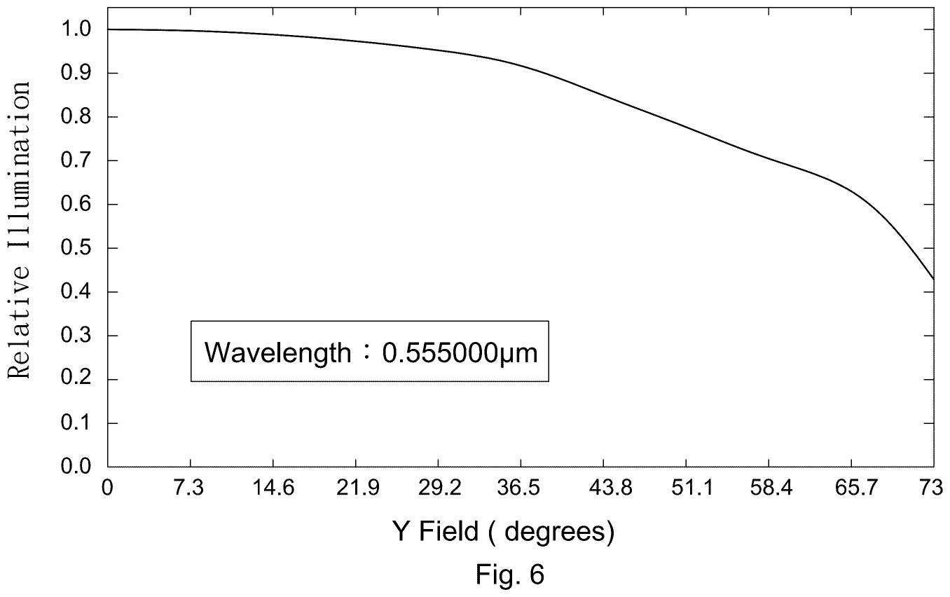

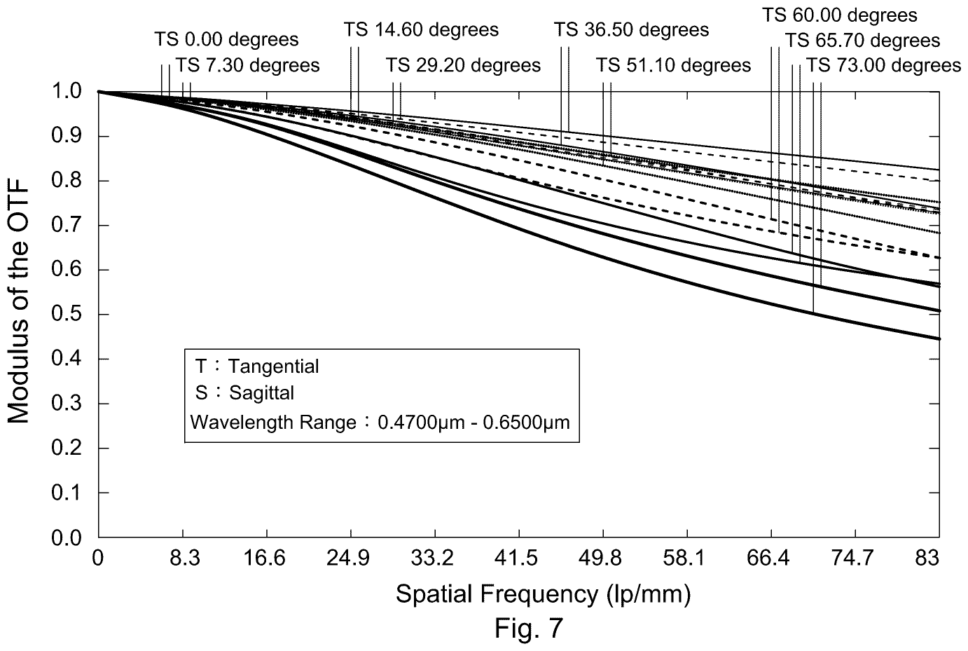

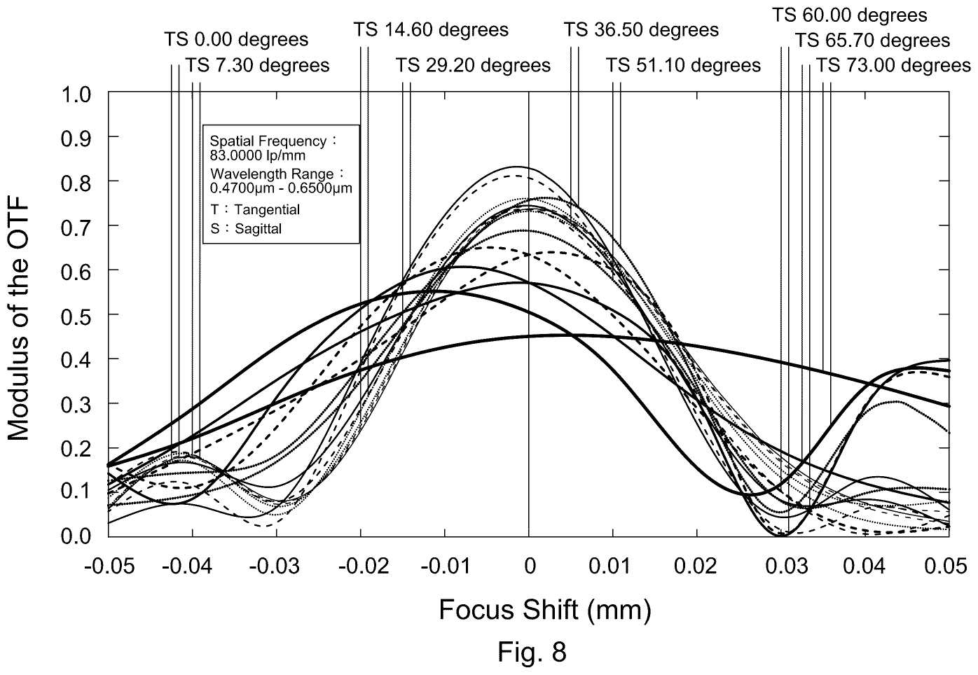

In addition, the wide-angle lens assembly 1 of the first embodiment can meet the requirements of optical performance as seen in FIGS. 2-8. It can be seen from FIG. 2 that the longitudinal aberration in the wide-angle lens assembly 1 of the first embodiment ranges from −0.03 mm to 0.025 mm. It can be seen from FIG. 3 that the field curvature of tangential direction and sagittal direction in the wide-angle lens assembly 1 of the first embodiment ranges from −0.04 mm to 0.07 mm. It can be seen from FIG. 4 that the distortion in the wide-angle lens assembly 1 of the first embodiment ranges from −6% to 0%. It can be seen from FIG. 5 that the lateral color in the wide-angle lens assembly 1 of the first embodiment ranges from −0.5 μm to 8.5 μm. It can be seen from FIG. 6 that the relative illumination in the wide-angle lens assembly 1 of the first embodiment ranges from 0.43 to 1.0. It can be seen from FIG. 7 that the modulation transfer function of tangential direction and sagittal direction in the wide-angle lens assembly 1 of the first embodiment ranges from 0.45 to 1.0. It can be seen from FIG. 8 that the through focus modulation transfer function of tangential direction and sagittal direction in the wide-angle lens assembly 1 of the first embodiment ranges from 0.0 to 0.83 as focus shift ranges from −0.05 mm to 0.05 mm. It is obvious that the longitudinal aberration, the field curvature, the distortion, the lateral color, and the relative illumination of the wide-angle lens assembly 1 of the first embodiment can be corrected effectively, and the resolution and the depth of focus of the wide-angle lens assembly 1 of the first embodiment can meet the requirement. Therefore, the wide-angle lens assembly 1 of the first embodiment is capable of good optical performance.

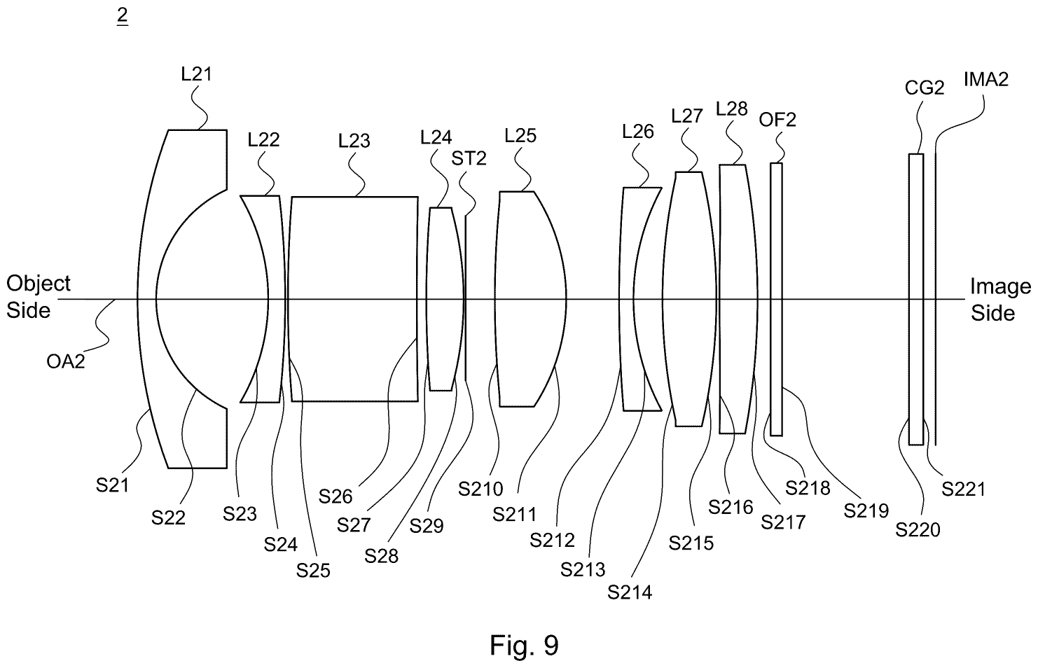

A detailed description of a wide-angle lens assembly in accordance with a second embodiment of the invention is as follows. Referring to FIG. 9, the wide-angle lens assembly 2 includes a first lens L21, a second lens L22, a third lens L23, a fourth lens L24, a stop ST2, a fifth lens L25, a sixth lens L26, a seventh lens L27, an eighth lens L28, an optical filter OF2, and a cover glass CG2, all of which are arranged in order from an object side to an image side along an optical axis OA2. In operation, the light from the object side is imaged on an image plane IMA2.

According to the foregoing, wherein: the second lens L22 is a meniscus lens, wherein the object side surface S23 is a concave surface and the image side surface S24 is a convex surface; the third lens L23 is a meniscus lens with positive refractive power, wherein the object side surface S25 is a convex surface, the image side surface S26 is a concave surface, and both of the object side surface S25 and image side surface S26 are spherical surfaces; both of the object side surface S27 and image side surface S28 of the fourth lens L24 are aspheric surfaces; both of the object side surface S210 and image side surface S211 of the fifth lens L25 are spherical surfaces; the sixth lens L26 is a meniscus lens with negative refractive power, wherein the object side surface S212 is a convex surface and the image side surface S213 is a concave surface; the seventh lens L27 is a biconvex lens with positive refractive power, wherein the object side surface S214 is a convex surface and the image side surface S215 is a convex surface; both of the object side surface S216 and image side surface S217 of the eighth lens L28 are aspheric surfaces; both of the object side surface S218 and image side surface S219 of the optical filter OF2 are plane surfaces; both of the object side surface S220 and image side surface S221 of the cover glass CG2 are plane surfaces; and with the above design of the lenses, stop ST2, and at least one of the conditions (1)-(15) satisfied, the wide-angle lens assembly 2 can have an effective increased field of view, an effective increased resolution, an effective resisted environment temperature change, and an effective corrected aberration. When the wide-angle lens assembly of the present invention only satisfies condition (3) or condition (4); and the refractive surface shape in independent claim; the basic operation requirements can be met.

Table 4 shows the optical specification of the wide-angle lens assembly 2 in FIG. 9.

TABLE 4
Effective Focal Length = 4.27 mm F-number = 1.78
Total Lens Length = 28.00 mm Field of View = 120.00 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S21 | 17.03 | 0.65 | 1.88 | 40.81 | −6.53 | L21 |
| S22 | 4.25 | 3.93 | | | | |
| S23 | −7.24 | 0.58 | 1.64 | 60.21 | −14.39 | L22 |
| S24 | −34.52 | 0.12 | | | | |
| S25 | 48.29 | 4.51 | 1.96 | 17.47 | 76.95 | L23 |
| S26 | 130.75 | 0.33 | | | | |
| S27 | 27.64 | 1.34 | 1.85 | 40.60 | 8.92 | L24 |
| S28 | −10.27 | 0.05 | | | | |
| S29 | ∞ | 1.04 | | | | ST2 |
| S210 | 38.28 | 2.49 | 1.54 | 74.70 | 11.10 | L25 |
| S211 | −6.93 | 1.86 | | | | |
| S212 | 50.00 | 0.50 | 1.96 | 17.47 | −10.20 | L26 |
| S213 | 8.21 | 1.01 | | | | |
| S214 | 19.59 | 1.90 | 1.73 | 54.67 | 13.67 | L27 |
| S215 | −19.59 | 0.10 | | | | |
| S216 | 72.62 | 1.29 | 1.85 | 40.60 | 34.86 | L28 |
| S217 | −50.00 | 0.50 | | | | |
| S218 | ∞ | 0.40 | 1.52 | 54.00 | | OF2 |
| S219 | ∞ | 4.46 | | | | |
| S220 | ∞ | 0.50 | 1.52 | 54.00 | | CG2 |
| S221 | ∞ | 0.44 | | | | |

In the second embodiment, the conic constant k and the aspheric coefficients A, B, C, D, E, F of each aspheric lens are shown in Table 5.

TABLE 5

| Surface | | | | | | | |
|---|---|---|---|---|---|---|---|
| Number | k | A | B | C | D | E | F |
| S27 | −8.7311 | −5.6877E−04 | 1.7781E−05 | 4.2417E−08 | 0 | 0 | 0 |
| S28 | 4.0901 | 8.6280E−04 | 1.8707E−05 | 1.9203E−06 | 0 | 0 | 0 |
| S216 | −0.1836 | −5.2350E−04 | 3.8458E−06 | 2.8152E−07 | 0 | 0 | 0 |
| S217 | 57.9004 | −4.8310E−04 | 6.2388E−06 | 1.7041E−07 | 0 | 0 | 0 |

Table 6 shows the parameters and condition values for conditions (1)-(15) in accordance with the second embodiment of the invention. It can be seen from Table 6 that the wide-angle lens assembly 2 of the second embodiment satisfies the conditions (1)-(15).

TABLE 6

| | | | | | |
|---|---|---|---|---|---|
| BFL | 6.29 mm | T5 | 2.49 mm | T7 | 1.90 mm |
| d45 | 1.09 mm | | | | |
| \|f2/f\| | 3.37 | \|f4/f\| | 2.09 | \|f5/f\| | 2.60 |
| \|f8/f\| | 8.16 | (R51 − R52)/T5 | 18.18 | (R71 − R72)/T7 | 20.58 |
| f1/f | −1.53 | HFOV/f | 28.10 degrees/ | HFOV/f3 | 1.56 degrees/ |
| | | | mm | | mm |
| HFOV/f4 | 13.46 degrees/ | HFOV/f5 | 10.81 degrees/ | HFOV/f7 | 8.78 degrees/ |
| | mm | | mm | | mm |
| HFOV/f8 | 3.44 degrees/ | TTL/d45 | 25.77 | TTL/BFL | 4.45 |
| | mm | | | | |

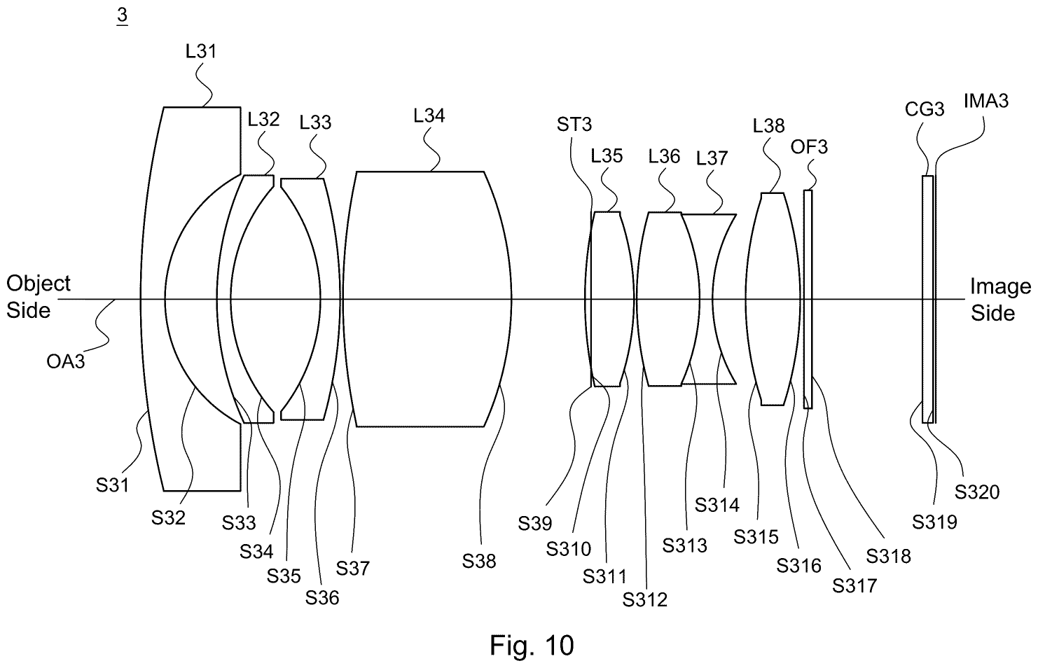

A detailed description of a wide-angle lens assembly in accordance with a third embodiment of the invention is as follows. Referring to FIG. 10, the wide-angle lens assembly 3 includes a first lens L31, a second lens L32, a third lens L33, a fourth lens L34, a stop ST3, a fifth lens L35, a sixth lens L36, a seventh lens L37, an eighth lens L38, an optical filter OF3, and a cover glass CG3, all of which are arranged in order from an object side to an image side along an optical axis OA3. In operation, the light from the object side is imaged on an image plane IMA3.

According to the foregoing, wherein: the second lens L32 is a meniscus lens, wherein the object side surface S33 is a convex surface and the image side surface S34 is a concave surface; the third lens L33 is a meniscus lens with negative refractive power, wherein the object side surface S35 is a concave surface, the image side surface S36 is a convex surface, and both of the object side surface S35 and image side surface S36 are spherical surfaces; both of the object side surface S37 and image side surface S38 of the fourth lens L34 are aspheric surfaces; both of the object side surface S310 and image side surface S311 of the fifth lens L35 are aspheric surfaces; the sixth lens L36 is a biconvex lens with positive refractive power, wherein the object side surface S312 is a convex surface and the image side surface S313 is a convex surface; the seventh lens L37 is a biconcave lens with negative refractive power, wherein the object side surface S313 is a concave surface and the image side surface S314 is a concave surface; the sixth lens L36 and the seventh lens L37 are cemented with no air gap between them; both of the object side surface S315 and image side surface S316 of the eighth lens L38 are aspheric surfaces; both of the object side surface S317 and image side surface S318 of the optical filter OF3 are plane surfaces; both of the object side surface S319 and image side surface S320 of the cover glass CG3 are plane surfaces; and with the above design of the lenses, stop ST3, and at least one of the conditions (1)-(15) satisfied, the wide-angle lens assembly 3 can have an effective increased field of view, an effective increased resolution, an effective resisted environment temperature change, and an effective corrected aberration. When the wide-angle lens assembly of the present invention only satisfies condition (5) or condition (6); and the refractive surface shape in independent claim; the basic operation requirements can be met.

Table 7 shows the optical specification of the wide-angle lens assembly 3 in FIG. 10.

TABLE 7
Effective Focal Length = 3.98 mm F-number = 1.64
Total Lens Length = 30.03 mm Field of View = 120.00 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S31 | 27.58 | 1.00 | 1.91 | 35.25 | −7.27 | L31 |
| S32 | 5.28 | 1.97 | | | | |
| S33 | 11.11 | 0.50 | 1.59 | 61.25 | −25.73 | L32 |
| S34 | 6.31 | 3.42 | | | | |
| S35 | −6.63 | 0.70 | 1.50 | 66.02 | −22.15 | L33 |
| S36 | −17.00 | 0.10 | | | | |
| S37 | 17.49 | 6.36 | 1.85 | 40.11 | 8.25 | L34 |
| S38 | −9.87 | 3.00 | | | | |
| S39 | ∞ | −0.25 | | | | ST3 |
| S310 | 15.66 | 1.86 | 1.49 | 84.47 | 12.08 | L35 |
| S311 | −9.09 | 0.09 | | | | |
| S312 | 11.63 | 2.39 | 1.59 | 68.62 | 8.11 | L36 |
| S313 | −7.61 | 0.50 | 1.79 | 25.72 | −4.26 | L37 |
| S314 | 6.22 | 1.25 | | | | |
| S315 | 12.46 | 2.03 | 1.59 | 61.15 | 11.75 | L38 |
| S316 | −14.75 | 0.15 | | | | |
| S317 | ∞ | 0.30 | 1.52 | 64.00 | | OF3 |
| S318 | ∞ | 4.16 | | | | |
| S319 | ∞ | 0.40 | 1.52 | 64.00 | | CG3 |
| S320 | ∞ | 0.10 | | | | |

In the third embodiment, the conic constant k and the aspheric coefficients A, B, C, D, E, F of each aspheric lens are shown in Table 8.

TABLE 8

| Surface | | | | | | | |
|---|---|---|---|---|---|---|---|
| Number | k | A | B | C | D | E | F |
| S37 | 0 | −2.0443E−04 | 3.8556E−07 | −9.1589E−08 | 0 | 0 | 0 |
| S38 | −2.3334 | 1.7348E−04 | −5.6513E−06 | 6.0521E−08 | 0 | 0 | 0 |
| S310 | 6.6739 | 3.7455E−04 | −2.5781E−05 | 3.0303E−07 | 0 | 0 | 0 |
| S311 | −1.3709 | 3.1452E−04 | −1.2501E−05 | 3.3931E−07 | 0 | 0 | 0 |
| S315 | 4.5633 | −3.0145E−04 | −1.1298E−05 | −3.6911E−07 | 0 | 0 | 0 |
| S316 | −31.1337 | −1.1379E−03 | 4.0270E−05 | −1.6958E−06 | 0 | 0 | 0 |

Table 9 shows the parameters and condition values for conditions (1)-(15) in accordance with the third embodiment of the invention. It can be seen from Table 9 that the wide-angle lens assembly 3 of the third embodiment satisfies the conditions (1)-(15).

TABLE 9

| | | | | | |
|---|---|---|---|---|---|
| BFL | 5.11 mm | T5 | 1.86 mm | T7 | 0.50 mm |
| d45 | 2.75 mm | | | | |
| \|f2/f\| | 6.47 | \|f4/f\| | 2.07 | \|f5/f] | 3.04 |
| \|f8/f\| | 2.95 | (R51 − R52)/T5 | 13.27 | (R71 − R72)/T7 | −27.81 |
| f1/f | −1.83 | HFOV/f | 30.15 degrees/ | HFOV/f3 | −5.42 degrees/ |
| | | | mm | | mm |
| HFOV/f4 | 14.55 degrees/ | HFOV/f5 | 9.93 degrees/ | HFOV/f7 | −28.20 degrees/ |
| | mm | | mm | | mm |
| HFOV/f8 | 10.22 degrees/ | TTL/d45 | 10.94 | TTL/BFL | 5.88 |
| | mm | | | | |

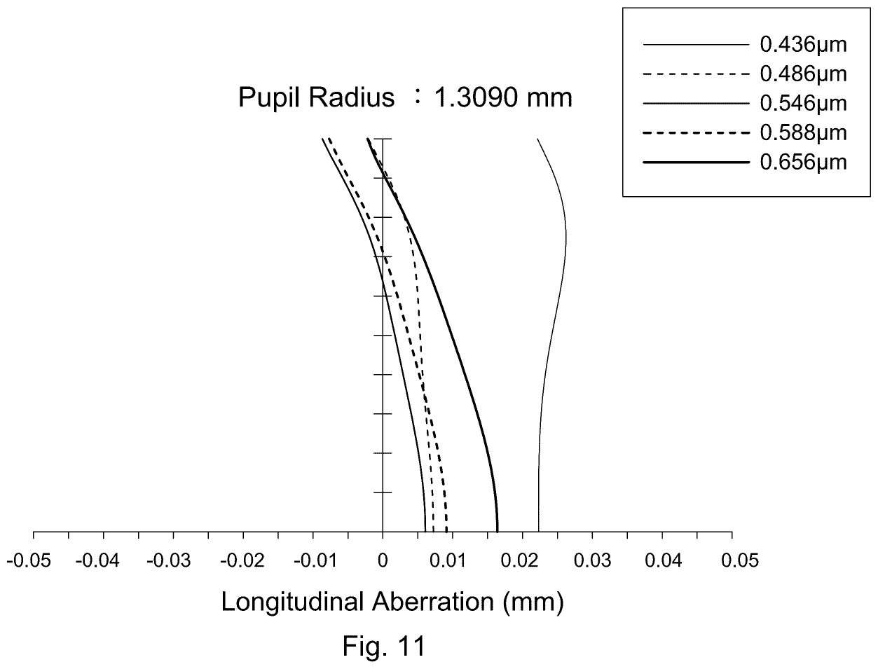

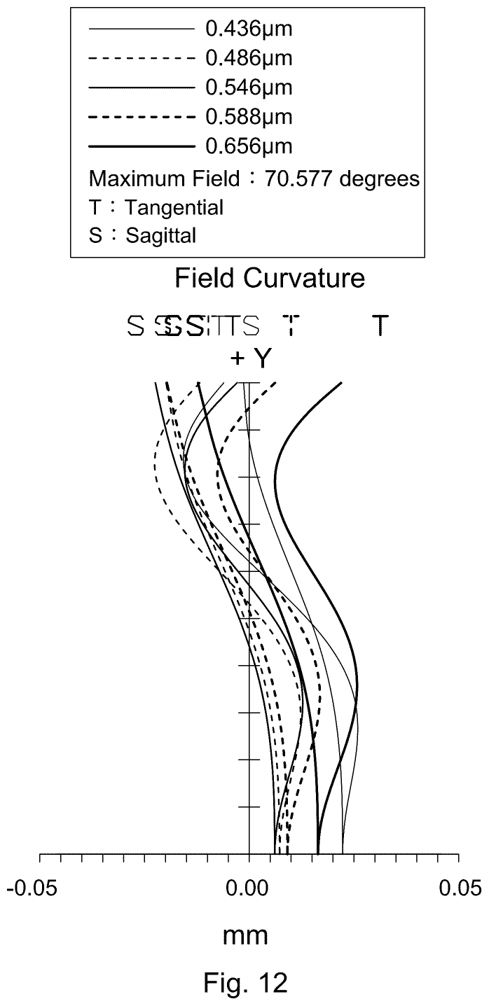

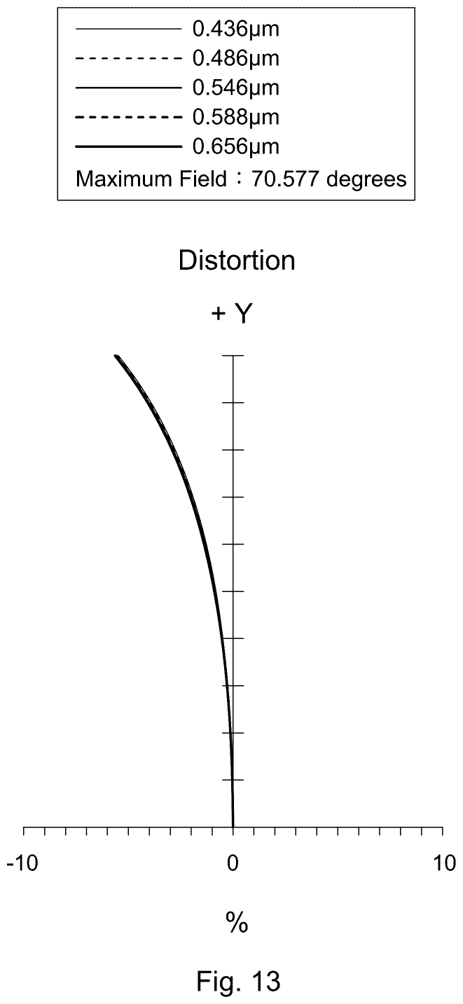

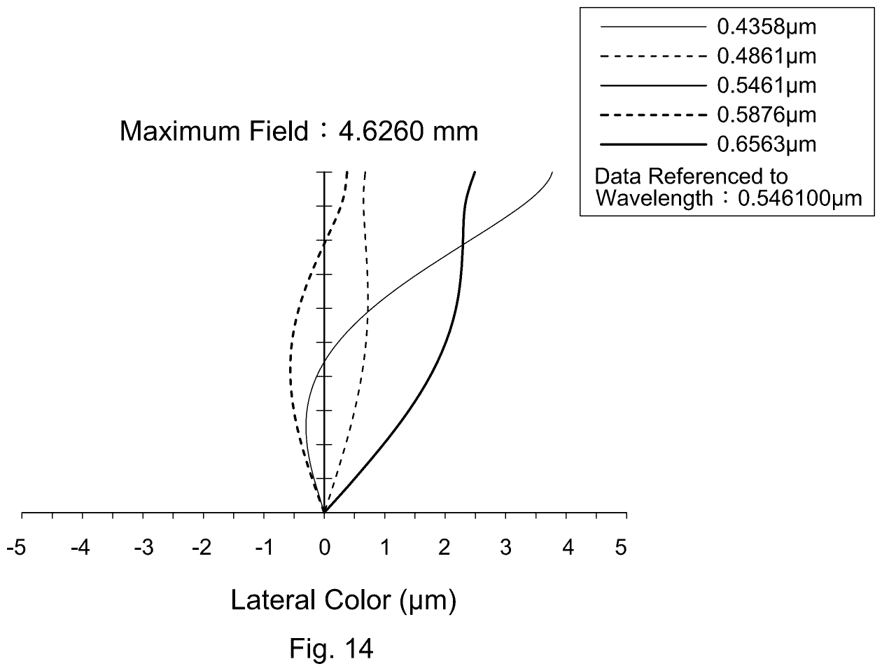

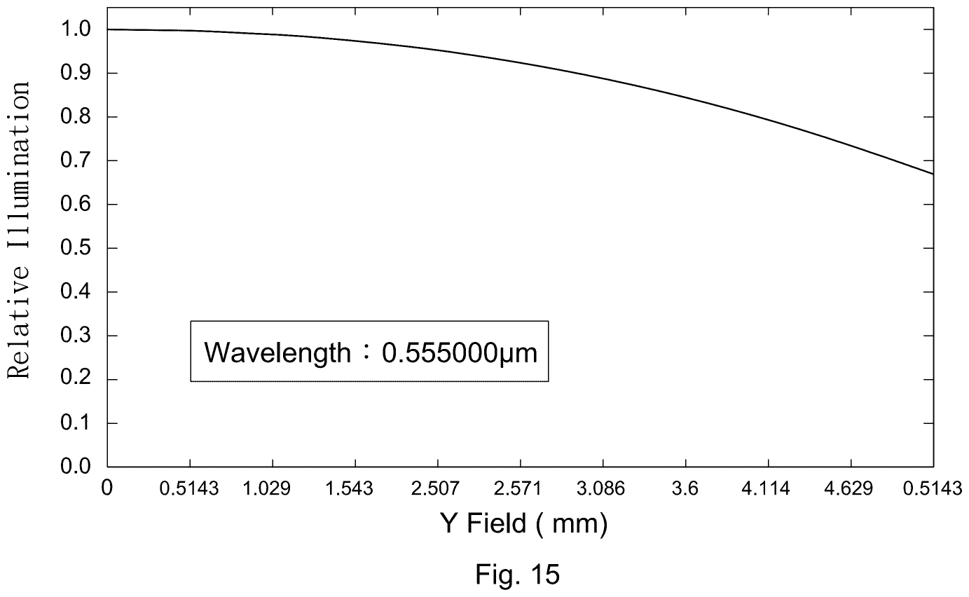

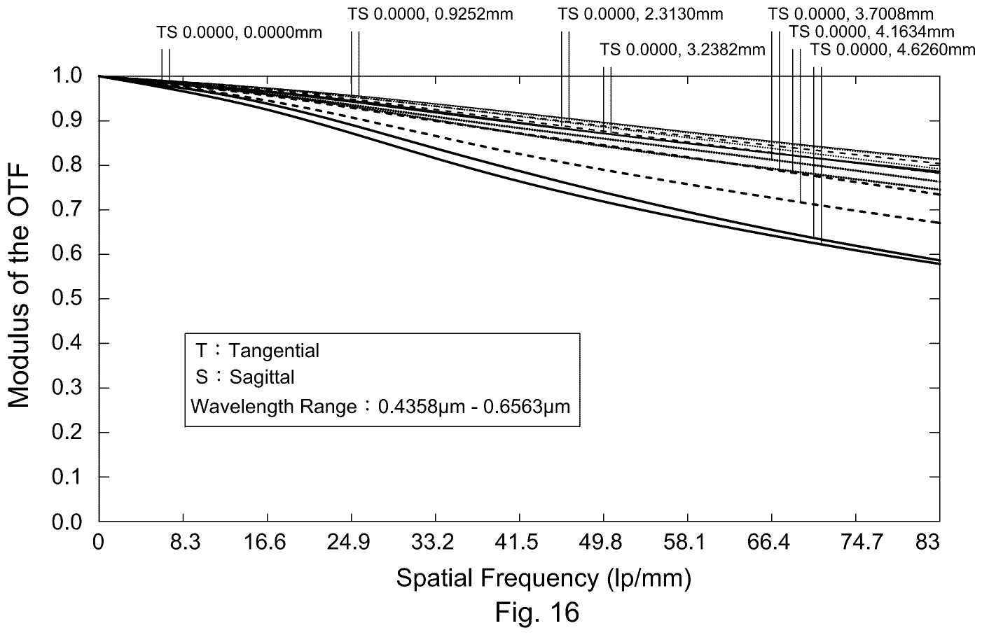

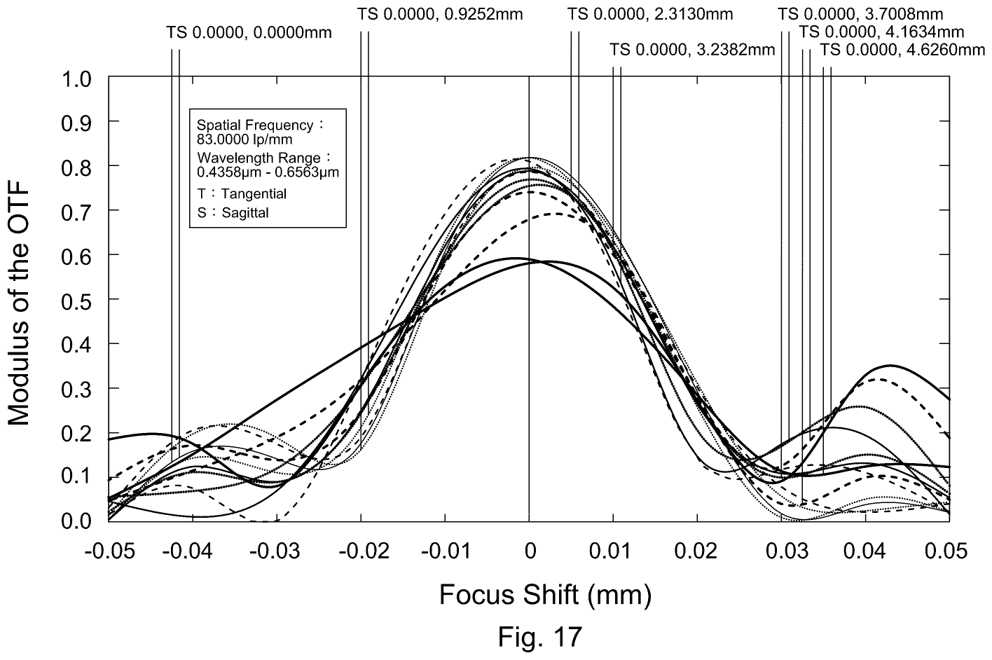

In addition, the wide-angle lens assembly 3 of the third embodiment can meet the requirements of optical performance as seen in FIGS. 11-17. It can be seen from FIG. 11 that the longitudinal aberration in the wide-angle lens assembly 3 of the third embodiment ranges from −0.01 mm to 0.03 mm. It can be seen from FIG. 12 that the field curvature of tangential direction and sagittal direction in the wide-angle lens assembly 3 of the third embodiment ranges from −0.025 mm to 0.025 mm. It can be seen from FIG. 13 that the distortion in the wide-angle lens assembly 3 of the third embodiment ranges from −6% to 0%. It can be seen from FIG. 14 that the lateral color in the wide-angle lens assembly 3 of the third embodiment ranges from −0.6 μm to 4.0 μm. It can be seen from FIG. 15 that the relative illumination in the wide-angle lens assembly 3 of the third embodiment ranges from 0.67 to 1.0. It can be seen from FIG. 16 that the modulation transfer function of tangential direction and sagittal direction in the wide-angle lens assembly 3 of the third embodiment ranges from 0.58 to 1.0. It can be seen from FIG. 17 that the through focus modulation transfer function of tangential direction and sagittal direction in the wide-angle lens assembly 3 of the third embodiment ranges from 0.0 to 0.82 as focus shift ranges from −0.05 mm to 0.05 mm. It is obvious that the longitudinal aberration, the field curvature, the distortion, the lateral color, and the relative illumination of the wide-angle lens assembly 3 of the third embodiment can be corrected effectively, and the resolution and the depth of focus of the wide-angle lens assembly 3 of the third embodiment can meet the requirement. Therefore, the wide-angle lens assembly 3 of the third embodiment is capable of good optical performance.

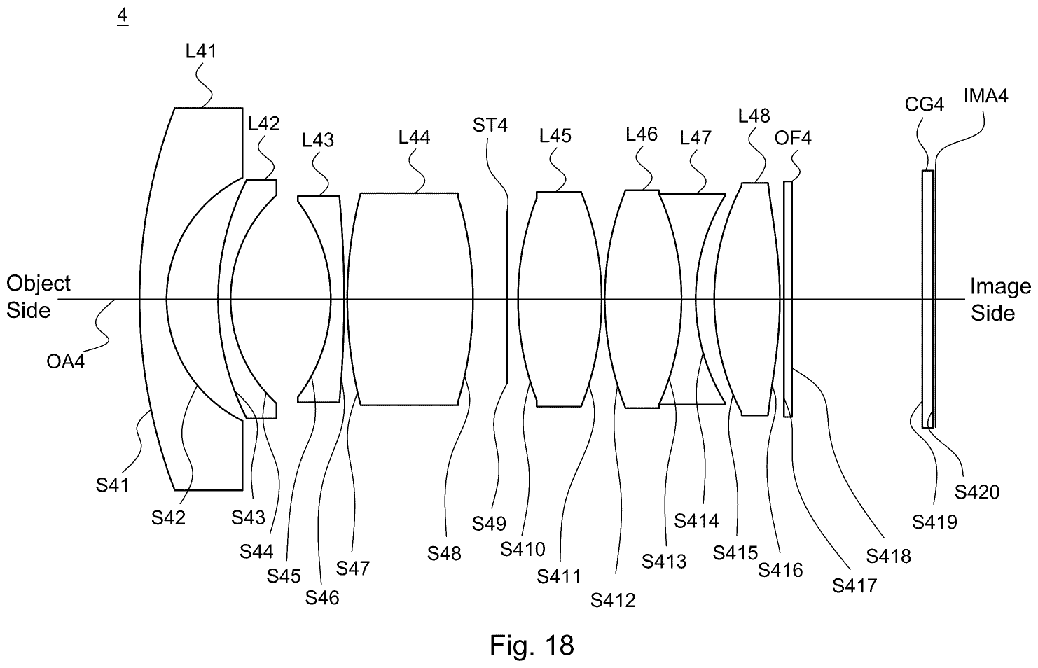

A detailed description of a wide-angle lens assembly in accordance with a fourth embodiment of the invention is as follows. Referring to FIG. 18, the wide-angle lens assembly 4 includes a first lens L41, a second lens L42, a third lens L43, a fourth lens L44, a stop ST4, a fifth lens L45, a sixth lens L46, a seventh lens L47, an eighth lens L48, an optical filter OF4, and a cover glass CG4, all of which are arranged in order from an object side to an image side along an optical axis OA4. In operation, the light from the object side is imaged on an image plane IMA4.

According to the foregoing, wherein: the second lens L42 is a meniscus lens, wherein the object side surface S43 is a convex surface and the image side surface S44 is a concave surface; the third lens L43 is a meniscus lens with negative refractive power, wherein the object side surface S45 is a concave surface, the image side surface S46 is a convex surface, and both of the object side surface S45 and image side surface S46 are spherical surfaces; both of the object side surface S47 and image side surface S48 of the fourth lens L44 are aspheric surfaces; both of the object side surface S410 and image side surface S411 of the fifth lens L45 are aspheric surfaces; the sixth lens L46 is a biconvex lens with positive refractive power, wherein the object side surface S412 is a convex surface and the image side surface S413 is a convex surface; the seventh lens L47 is a biconcave lens with negative refractive power, wherein the object side surface S413 is a concave surface and the image side surface S414 is a concave surface; the sixth lens L46 and the seventh lens L47 are cemented with no air gap between them; both of the object side surface S415 and image side surface S416 of the eighth lens L48 are aspheric surfaces; both of the object side surface S417 and image side surface S418 of the optical filter OF4 are plane surfaces; both of the object side surface S419 and image side surface S420 of the cover glass CG4 are plane surfaces; and with the above design of the lenses, stop ST4, and at least one of the conditions (1)-(15) satisfied, the wide-angle lens assembly 4 can have an effective increased field of view, an effective increased resolution, an effective resisted environment temperature change, and an effective corrected aberration. When the wide-angle lens assembly of the present invention only satisfies condition (7) and the refractive surface shape in independent claim; the basic operation requirements can be met.

Table 10 shows the optical specification of the wide-angle lens assembly 4 in FIG. 18.

TABLE 10
Effective Focal Length = 3.92 mm F-number = 1.72
Total Lens Length = 29.66 mm Field of View = 120.00 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S41 | 19.74 | 1.00 | 1.88 | 40.81 | −7.79 | L41 |
| S42 | 5.00 | 1.94 | | | | |
| S43 | 9.82 | 0.50 | 1.52 | 64.14 | −23.26 | L42 |
| S44 | 5.32 | 3.69 | | | | |
| S45 | −5.99 | 0.50 | 1.59 | 68.62 | −11.89 | L43 |
| S46 | −40.50 | 0.10 | | | | |
| S47 | 15.38 | 4.69 | 1.85 | 40.58 | 8.27 | L44 |
| S48 | −11.23 | 1.27 | | | | |
| S49 | ∞ | 0.42 | | | | ST4 |
| S410 | 11.37 | 3.13 | 1.49 | 84.47 | 11.21 | L45 |
| S411 | −9.52 | 0.10 | | | | |
| S412 | 11.11 | 2.88 | 1.53 | 76.98 | 9.98 | L46 |
| S413 | −9.20 | 0.50 | 1.79 | 25.72 | −5.09 | L47 |
| S414 | 7.35 | 0.69 | | | | |
| S415 | 9.20 | 2.44 | 1.59 | 61.15 | 10.17 | L48 |
| S416 | −15.38 | 0.15 | | | | |
| S417 | ∞ | 0.30 | 1.52 | 64.00 | | OF4 |
| S418 | ∞ | 4.86 | | | | |
| S419 | ∞ | 0.40 | 1.52 | 64.00 | | CG4 |
| S420 | ∞ | 0.10 | | | | |

In the fourth embodiment, the conic constant k and the aspheric coefficients A, B, C, D, E, F of each aspheric lens are shown in Table 11.

TABLE 11

| Surface | | | | | | | |
|---|---|---|---|---|---|---|---|
| Number | k | A | B | C | D | E | F |
| S47 | −1.8993 | 6.2265E−05 | 6.4334E−06 | −4.4682E−07 | 0 | 0 | 0 |
| S48 | −6.9307 | −5.5431E−05 | 1.1106E−05 | −3.1621E−07 | 0 | 0 | 0 |
| S410 | −3.3951 | 6.2771E−04 | −1.0296E−05 | 1.4521E−07 | 0 | 0 | 0 |
| S411 | 0.3200 | 2.3169E−04 | 1.3481E−05 | −2.0437E−07 | 0 | 0 | 0 |
| S415 | −2.5774 | 1.9725E−04 | 1.8607E−05 | −4.7284E−07 | 0 | 0 | 0 |
| S416 | −28.8367 | −5.8271E−04 | 4.7160E−05 | −9.2899E−07 | 0 | 0 | 0 |

Table 12 shows the parameters and condition values for conditions (1)-(15) in accordance with the fourth embodiment of the invention. It can be seen from Table 12 that the wide-angle lens assembly 4 of the fourth embodiment satisfies the conditions (1)-(15).

TABLE 12

| | | | | | |
|---|---|---|---|---|---|
| BFL | 5.81 mm | T5 | 3.13 mm | T7 | 0.50 mm |
| d45 | 1.69 mm | | | | |
| \|f2/f\| | 5.94 | \|f4/f\| | 2.11 | \|f5/f\| | 2.86 |
| \|f8/f\| | 2.60 | (R51 − R52)/T5 | 6.68 | (R71 − R72)/T7 | −33.10 |
| f1/f | −1.99 | HFOV/f | 30.65 degrees/ | HFOV/f3 | −10.10 degrees/ |
| | | | mm | | mm |
| HFOV/f4 | 14.52 degrees/ | HFOV/f5 | 10.71 degrees/ | HFOV/f7 | −23.57 degrees/ |
| | mm | | mm | | mm |
| HFOV/f8 | 11.80 degrees/ | TTL/d45 | 17.58 | TTL/BFL | 5.11 |
| | mm | | | | |

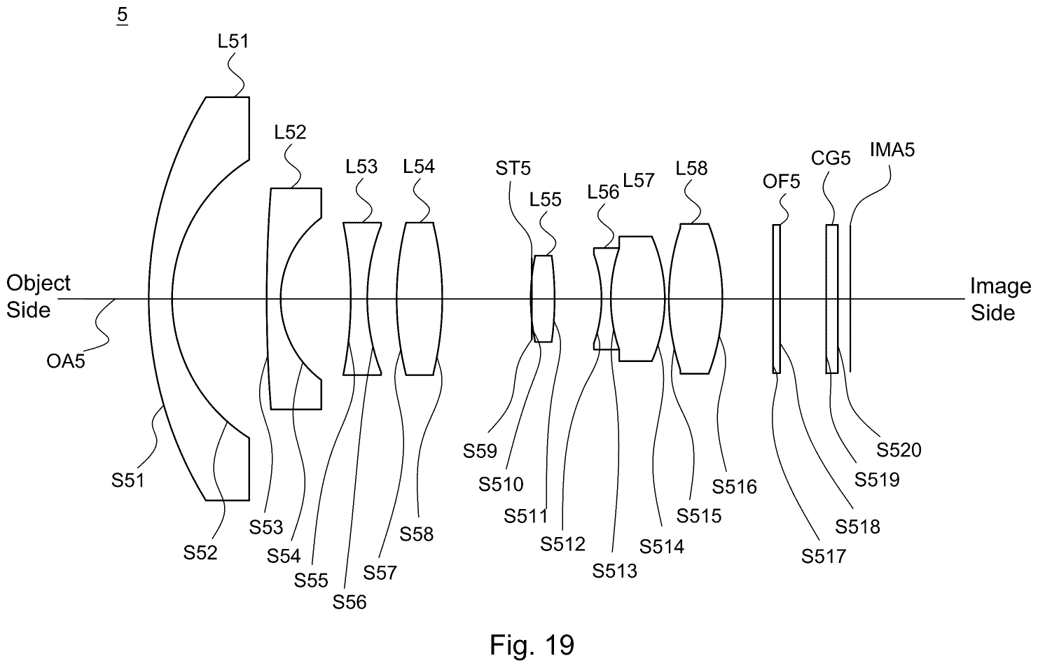

A detailed description of a wide-angle lens assembly in accordance with a fifth embodiment of the invention is as follows. Referring to FIG. 19, the wide-angle lens assembly 5 includes a first lens L51, a second lens L52, a third lens L53, a fourth lens L54, a stop ST5, a fifth lens L55, a sixth lens L56, a seventh lens L57, an eighth lens L58, an optical filter OF5, and a cover glass CG5, all of which are arranged in order from an object side to an image side along an optical axis OA5. In operation, the light from the object side is imaged on an image plane IMA5.

According to the foregoing, wherein: the second lens L52 is a meniscus lens, wherein the object side surface S53 is a convex surface and the image side surface S54 is a concave surface; the third lens L53 is a biconcave lens with negative refractive power, wherein the object side surface S55 is a concave surface, the image side surface S56 is a concave surface, and both of the object side surface S55 and image side surface S56 are aspheric surfaces; both of the object side surface S57 and image side surface S58 of the fourth lens L54 are spherical surfaces; both of the object side surface S510 and image side surface S511 of the fifth lens L55 are spherical surfaces; the sixth lens L56 is a biconcave lens with negative refractive power, wherein the object side surface S512 is a concave surface and the image side surface S513 is a concave surface; the seventh lens L57 is a biconvex lens with positive refractive power, wherein the object side surface S513 is a convex surface and the image side surface S514 is a convex surface; the sixth lens L56 and the seventh lens L57 are cemented with no air gap between them; both of the object side surface S515 and image side surface S516 of the eighth lens L58 are aspheric surfaces; both of the object side surface S517 and image side surface S518 of the optical filter OF5 are plane surfaces; both of the object side surface S519 and image side surface S520 of the cover glass CG5 are plane surfaces; and with the above design of the lenses, stop ST5, and at least one of the conditions (1)-(15) satisfied, the wide-angle lens assembly can have an effective increased field of view, an effective increased resolution, an effective resisted environment temperature change, and an effective corrected aberration. When the wide-angle lens assembly of the present invention only satisfies condition (8) and the refractive surface shape in independent claim; the basic operation requirements can be met.

Table 13 shows the optical specification of the wide-angle lens assembly 5 in FIG. 19.

TABLE 13
Effective Focal Length = 2.33 F-number = 2.20 mm
Total Lens Length = 30.00 mm Field of View = 196.00 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S51 | 16.33 | 1.00 | 1.84 | 42.73 | −15.36 | L51 |
| S52 | 7.00 | 4.08 | | | | |
| S53 | 69.75 | 0.60 | 1.70 | 55.53 | −6.69 | L52 |
| S54 | 4.37 | 2.99 | | | | |
| S55 | −16.03 | 0.70 | 1.54 | 56.12 | −10.83 | L53 |
| S56 | 9.25 | 1.25 | | | | |
| S57 | 13.41 | 1.96 | 1.85 | 32.22 | 8.11 | L54 |
| S58 | −13.41 | 3.82 | | | | |
| S59 | ∞ | −0.05 | | | | ST5 |
| S510 | 8.85 | 1.03 | 1.69 | 54.82 | 7.73 | L55 |
| S511 | −12.95 | 2.00 | | | | |
| S512 | −5.77 | 0.40 | 1.85 | 23.78 | −3.59 | L56 |
| S513 | 6.73 | 2.31 | 1.59 | 68.34 | 6.05 | L57 |
| S514 | −6.73 | 0.18 | | | | |
| S515 | 8.38 | 2.28 | 1.55 | 56.00 | 8.31 | L58 |
| S516 | −8.94 | 2.17 | | | | |
| S517 | ∞ | 0.30 | 1.52 | 64.00 | | OF5 |
| S518 | ∞ | 1.97 | | | | |
| S519 | ∞ | 0.50 | 1.52 | 64.00 | | CG5 |
| S520 | ∞ | 0.53 | | | | |

In the fifth embodiment, the conic constant k and the aspheric coefficients A, B, C, D, E, F of each aspheric lens are shown in Table 14.

TABLE 14

| Surface | | | | | | | |
|---|---|---|---|---|---|---|---|
| Number | k | A | B | C | D | E | F |
| S55 | −4.0857 | −1.3980E−04 | −2.5517E−06 | 6.1554E−07 | 0 | 0 | 0 |
| S56 | 0 | 3.8008E−04 | 0 | 0 | 0 | 0 | 0 |
| S515 | −2.1863 | −6.3145E−04 | 9.2744E−06 | −4.2455E−07 | 0 | 0 | 0 |
| S516 | −1.4021 | −1.7051E−04 | −3.5442E−06 | 6.1834E−08 | 0 | 0 | 0 |

Table 15 shows the parameters and condition values for conditions (1)-(15) in accordance with the fifth embodiment of the invention. It can be seen from Table that the wide-angle lens assembly 5 of the fifth embodiment satisfies the conditions (1)-(15).

TABLE 15

| | | | | | |
|---|---|---|---|---|---|
| BFL | 5.47 mm | T5 | 1.03 mm | T7 | 2.31 mm |
| d45 | 3.77 mm | | | | |
| \|f2/f\| | 2.87 | \|f4/f\| | 3.48 | \|f5/f\| | 3.32 |
| \|f8/f\| | 3.57 | (R51 − R52)/T5 | 21.13 | (R71 − R72)/T7 | 5.82 |
| f1/f | −6.59 | HFOV/f | 84.08 degrees/ | HFOV/f3 | −18.10 degrees/ |
| | | | mm | | mm |
| HFOV/f4 | 24.16 degrees/ | HFOV/f5 | 25.35 degrees/ | HFOV/f7 | 32.42 degrees/ |
| | mm | | mm | | mm |
| HFOV/f8 | 23.58 degrees/ | TTL/d45 | 7.95 | TTL/BFL | 5.49 |
| | mm | | | | |

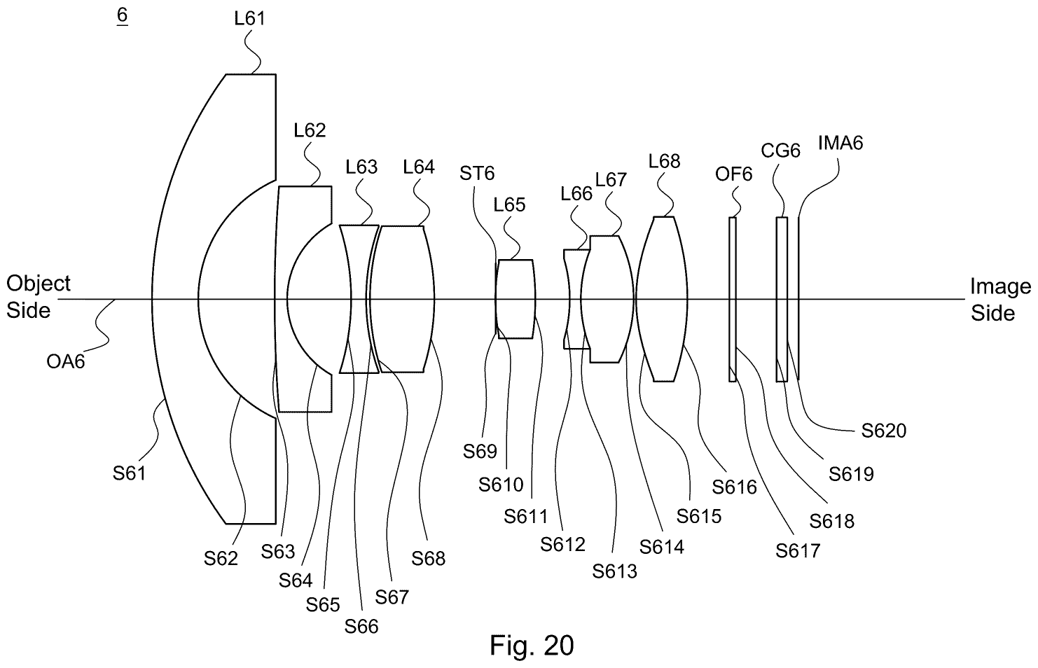

A detailed description of a wide-angle lens assembly in accordance with a sixth embodiment of the invention is as follows. Referring to FIG. 20, the wide-angle lens assembly 6 includes a first lens L61, a second lens L62, a third lens L63, a fourth lens L64, a stop ST6, a fifth lens L65, a sixth lens L66, a seventh lens L67, an eighth lens L68, an optical filter OF6, and a cover glass CG6, all of which are arranged in order from an object side to an image side along an optical axis OA6. In operation, the light from the object side is imaged on an image plane IMA6.

According to the foregoing, wherein: the second lens L62 is a meniscus lens, wherein the object side surface S63 is a convex surface and the image side surface S64 is a concave surface; the third lens L63 is a biconcave lens with negative refractive power, wherein the object side surface S65 is a concave surface, the image side surface S66 is a concave surface, and both of the object side surface S65 and image side surface S66 are aspheric surfaces; both of the object side surface S67 and image side surface S68 of the fourth lens L64 are spherical surfaces; both of the object side surface S610 and image side surface S611 of the fifth lens L65 are spherical surfaces; the sixth lens L66 is a biconcave lens with negative refractive power, wherein the object side surface S612 is a concave surface and the image side surface S613 is a concave surface; the seventh lens L67 is a biconvex lens with positive refractive power, wherein the object side surface S613 is a convex surface and the image side surface S614 is a convex surface; the sixth lens L66 and the seventh lens L67 are cemented with no air gap between them; both of the object side surface S615 and image side surface S616 of the eighth lens L68 are aspheric surfaces; both of the object side surface S617 and image side surface S618 of the optical filter OF6 are plane surfaces; both of the object side surface S619 and image side surface S620 of the cover glass CG6 are plane surfaces; and with the above design of the lenses, stop ST6, and at least one of the conditions (1)-(15) satisfied, the wide-angle lens assembly 6 can have an effective increased field of view, an effective increased resolution, an effective resisted environment temperature change, and an effective corrected aberration. When the wide-angle lens assembly of the present invention only satisfies condition (9) and the refractive surface shape in independent claim; the basic operation requirements can be met.

Table 16 shows the optical specification of the wide-angle lens assembly 6 in FIG. 20.

TABLE 16
Effective Focal Length = 2.36 mm F-number = 2.24
Total Lens Length = 30.02 mm Field of View = 196.00 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S61 | 17.92 | 2.13 | 1.84 | 42.73 | −12.03 | L61 |
| S62 | 6.11 | 3.52 | | | | |
| S63 | 65.96 | 0.60 | 1.70 | 55.53 | −6.21 | L62 |
| S64 | 4.06 | 2.97 | | | | |
| S65 | −12.50 | 0.69 | 1.54 | 56.12 | −10.33 | L63 |
| S66 | 10.15 | 0.19 | | | | |
| S67 | 10.93 | 2.98 | 1.85 | 32.22 | 6.82 | L64 |
| S68 | −10.93 | 2.86 | | | | |
| S69 | ∞ | −0.01 | | | | ST6 |
| S610 | 9.34 | 1.86 | 1.69 | 54.82 | 7.75 | L65 |
| S611 | −11.63 | 1.62 | | | | |
| S612 | −6.45 | 0.50 | 1.85 | 23.78 | −3.72 | L66 |
| S613 | 6.47 | 2.46 | 1.59 | 68.34 | 5.86 | L67 |
| S614 | −6.47 | 0.10 | | | | |
| S615 | 7.34 | 2.39 | 1.55 | 56.00 | 8.82 | L68 |
| S616 | −12.36 | 1.95 | | | | |
| S617 | ∞ | 0.30 | 1.52 | 64.00 | | OF6 |
| S618 | ∞ | 1.89 | | | | |
| S619 | ∞ | 0.50 | 1.52 | 64.00 | | CG6 |
| S620 | ∞ | 0.53 | | | | |

In the sixth embodiment, the conic constant k and the aspheric coefficients A, B, C, D, E, F of each aspheric lens are shown in Table 17.

TABLE 17

| Surface | | | | | | | |
|---|---|---|---|---|---|---|---|
| Number | k | A | B | C | D | E | F |
| S65 | −3.3480 | −6.5648E−04 | −1.0083E−06 | 5.0335E−07 | 0 | 0 | 0 |
| S66 | 0 | 2.4664E−05 | 0 | 0 | 0 | 0 | 0 |
| S615 | −1.6658 | −4.8749E−04 | 1.9553E−06 | 1.0562E−08 | 0 | 0 | 0 |
| S616 | −0.4520 | −1.4671E−04 | −8.4419E−06 | 3.9342E−07 | 0 | 0 | 0 |

Table 18 shows the parameters and condition values for conditions (1)-(15) in accordance with the sixth embodiment of the invention. It can be seen from Table 18 that the wide-angle lens assembly 6 of the sixth embodiment satisfies the conditions (1)-(15).

TABLE 18

| | | | | | |
|---|---|---|---|---|---|
| BFL | 5.17 mm | T5 | 1.86 mm | T7 | 2.46 mm |
| d45 | 2.85 mm | | | | |
| \|f2/f\| | 2.64 | \|f4/f\| | 2.89 | \|f5/f\| | 3.29 |
| \|f8/f\| | 3.74 | (R51 − R52)/T5 | 11.27 | (R71 − R72)/T7 | 5.25 |
| f1/f | −5.11 | HFOV/f | 83.16 degrees/ | HFOV/f3 | −18.98 degrees/ |
| | | | mm | | mm |
| HFOV/f4 | 28.74 degrees/ | HFOV/f5 | 25.28 degrees/ | HFOV/f7 | 33.47 degrees/ |
| | mm | | mm | | mm |
| HFOV/f8 | 22.23 degrees/ | TTL/d45 | 10.55 | TTL/BFL | 5.81 |
| | mm | | | | |

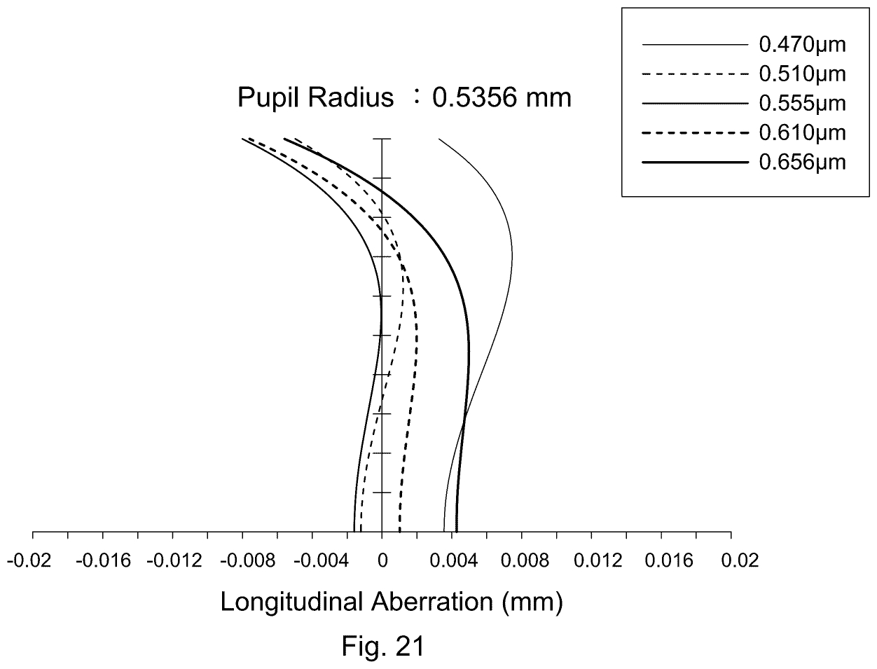

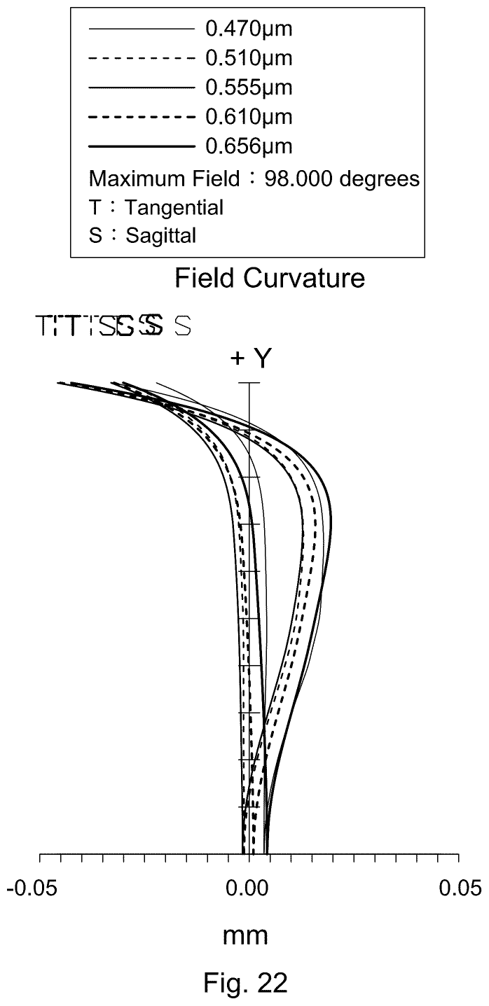

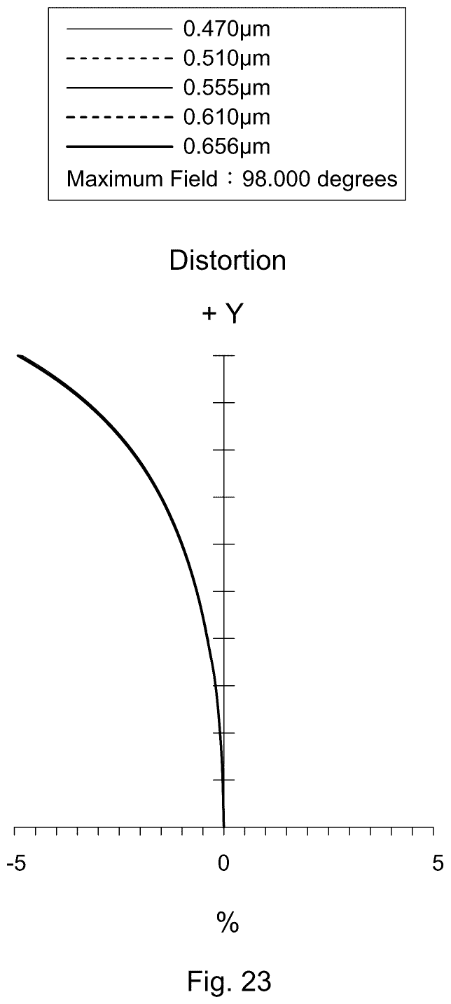

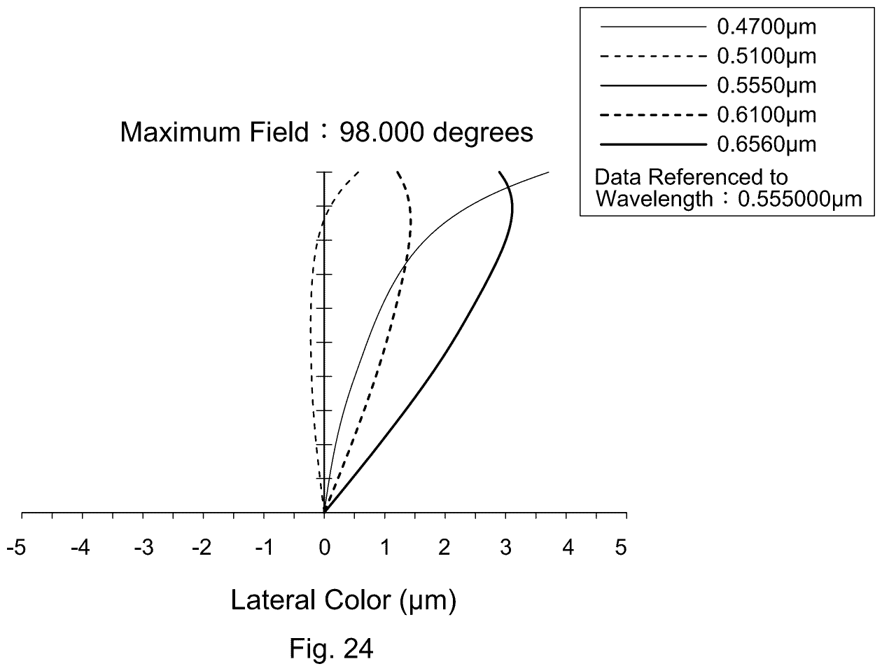

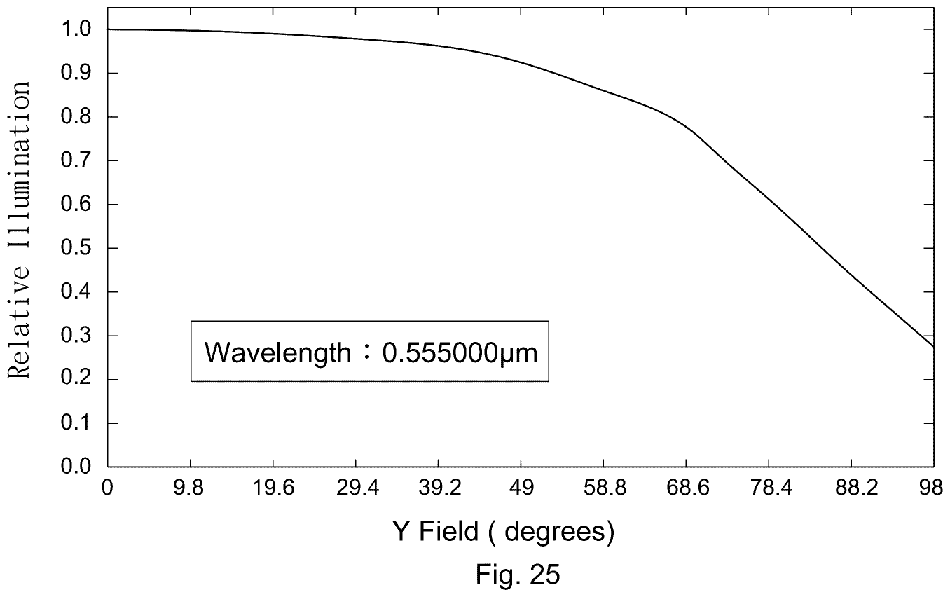

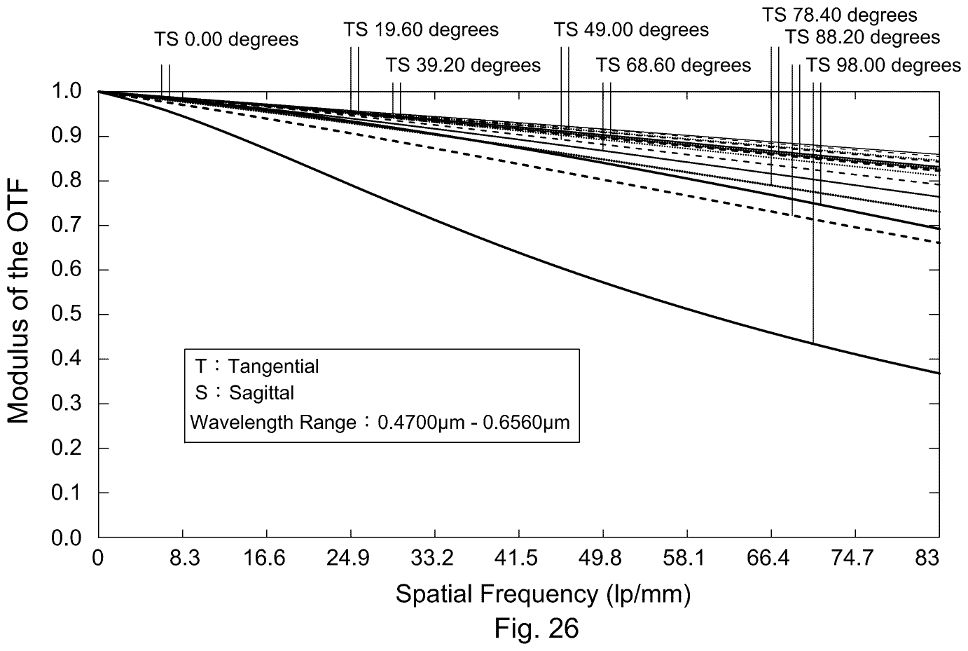

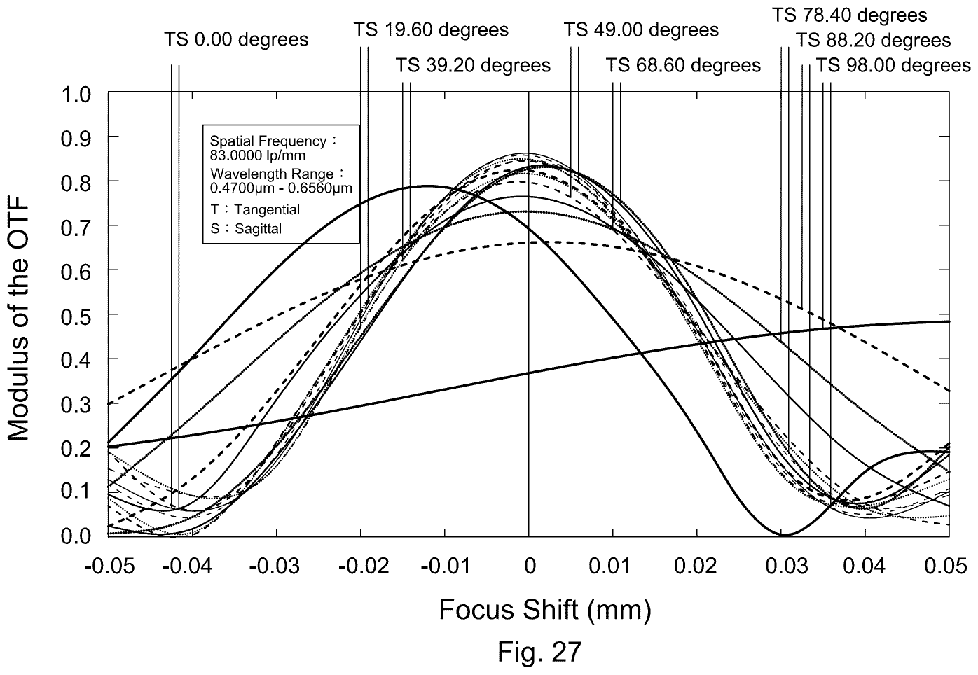

In addition, the wide-angle lens assembly 6 of the sixth embodiment can meet the requirements of optical performance as seen in FIGS. 21-27. It can be seen from FIG. 21 that the longitudinal aberration in the wide-angle lens assembly 6 of the sixth embodiment ranges from −0.008 mm to 0.008 mm. It can be seen from FIG. 22 that the field curvature of tangential direction and sagittal direction in the wide-angle lens assembly 6 of the sixth embodiment ranges from −0.05 mm to 0.02 mm. It can be seen from FIG. 23 that the distortion in the wide-angle lens assembly 6 of the sixth embodiment ranges from −5% to 0%. It can be seen from FIG. 24 that the lateral color in the wide-angle lens assembly 6 of the sixth embodiment ranges from −0.5 μm to 4.0 μm. It can be seen from FIG. 25 that the relative illumination in the wide-angle lens assembly 6 of the sixth embodiment ranges from 0.27 to 1.0. It can be seen from FIG. 26 that the modulation transfer function of tangential direction and sagittal direction in the wide-angle lens assembly 6 of the sixth embodiment ranges from 0.37 to 1.0. It can be seen from FIG. 27 that the through focus modulation transfer function of tangential direction and sagittal direction in the wide-angle lens assembly 6 of the sixth embodiment ranges from 0.0 to 0.86 as focus shift ranges from −0.05 mm to 0.05 mm. It is obvious that the longitudinal aberration, the field curvature, the distortion, the lateral color, and the relative illumination of the wide-angle lens assembly 6 of the sixth embodiment can be corrected effectively, and the resolution and the depth of focus of the wide-angle lens assembly 6 of the sixth embodiment can meet the requirement. Therefore, the wide-angle lens assembly 6 of the sixth embodiment is capable of good optical performance.

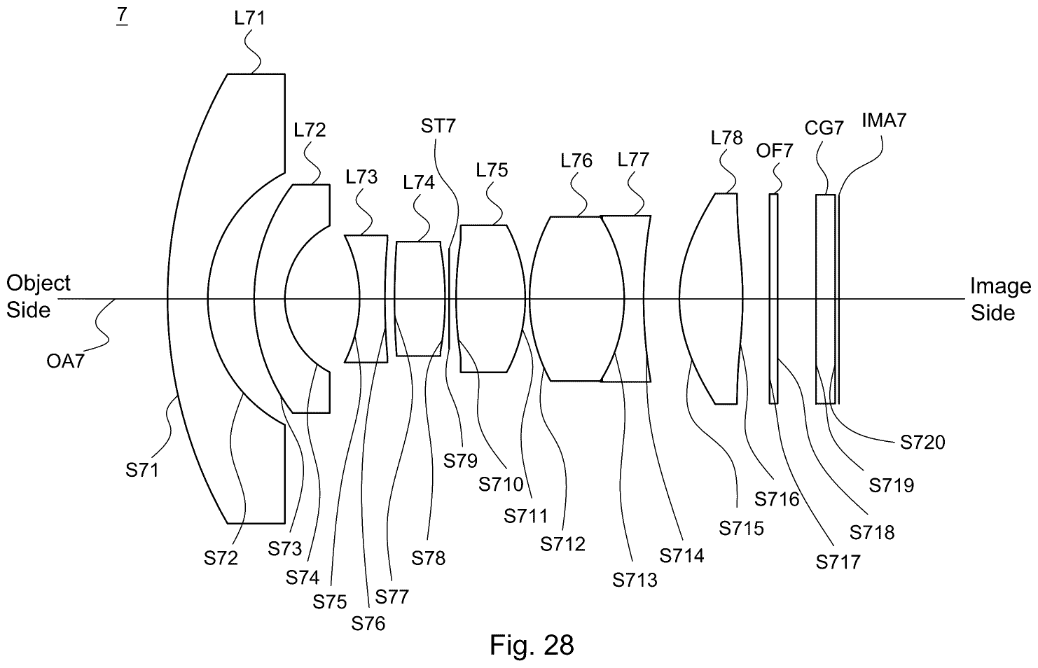

A detailed description of a wide-angle lens assembly in accordance with a seventh embodiment of the invention is as follows. Referring to FIG. 28, the wide-angle lens assembly 7 includes a first lens L71, a second lens L72, a third lens L73, a fourth lens L74, a stop ST7, a fifth lens L75, a sixth lens L76, a seventh lens L77, an eighth lens L78, an optical filter OF7, and a cover glass CG7, all of which are arranged in order from an object side to an image side along an optical axis OA7. In operation, the light from the object side is imaged on an image plane IMA7.

According to the foregoing, wherein: the second lens L72 is a meniscus lens, wherein the object side surface S73 is a convex surface and the image side surface S74 is a concave surface; the third lens L73 is a biconcave lens with negative refractive power, wherein the object side surface S75 is a concave surface, the image side surface S76 is a concave surface, and both of the object side surface S75 and image side surface S76 are aspheric surfaces; both of the object side surface S77 and image side surface S78 of the fourth lens L74 are aspheric surfaces; both of the object side surface S710 and image side surface S711 of the fifth lens L75 are spherical surfaces; the sixth lens L76 is a biconvex lens with positive refractive power, wherein the object side surface S712 is a convex surface and the image side surface S713 is a convex surface; the seventh lens L77 is a biconcave lens with negative refractive power, wherein the object side surface S713 is a concave surface and the image side surface S714 is a concave surface; the sixth lens L76 and the seventh lens L77 are cemented with no air gap between them; both of the object side surface S715 and image side surface S716 of the eighth lens L78 are aspheric surfaces; both of the object side surface S717 and image side surface S718 of the optical filter OF7 are plane surfaces; both of the object side surface S719 and image side surface S720 of the cover glass CG7 are plane surfaces; and with the above design of the lenses, stop ST7, and at least one of the conditions (1)-(15) satisfied, the wide-angle lens assembly 7 can have an effective increased field of view, an effective increased resolution, an effective resisted environment temperature change, and an effective corrected aberration. When the wide-angle lens assembly of the present invention only satisfies condition (10) or condition (11); and the refractive surface shape in independent claim; the basic operation requirements can be met.

Table 19 shows the optical specification of the wide-angle lens assembly 7 in FIG. 28.

TABLE 19
Effective Focal Length = 1.71 mm F-number = 2.00
Total Lens Length = 17.50 mm Field of View = 200.00 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S71 | 11.80 | 1.05 | 1.88 | 40.87 | −6.47 | L71 |
| S72 | 3.70 | 1.21 | | | | |
| S73 | 4.94 | 0.80 | 1.88 | 40.87 | −4.96 | L72 |
| S74 | 2.15 | 1.96 | | | | |
| S75 | −4.31 | 0.65 | 1.54 | 56.12 | −5.98 | L73 |
| S76 | 13.24 | 0.25 | | | | |
| S77 | 17.41 | 1.32 | 1.67 | 19.24 | 8.00 | L74 |
| S78 | −7.63 | 0.11 | | | | |
| S79 | ∞ | 0.18 | | | | ST7 |
| S710 | 10.25 | 1.80 | 1.60 | 67.74 | 5.09 | L75 |
| S711 | −4.03 | 0.10 | | | | |
| S712 | 4.44 | 2.48 | 1.50 | 81.61 | 4.68 | L76 |
| S713 | −4.00 | 0.50 | 1.92 | 18.90 | −3.22 | L77 |
| S714 | 12.74 | 0.93 | | | | |
| S715 | 3.68 | 1.65 | 1.54 | 56.12 | 5.20 | L78 |
| S716 | −9.79 | 0.70 | | | | |
| S717 | ∞ | 0.21 | 1.52 | 64.00 | | OF7 |
| S718 | ∞ | 1.00 | | | | |
| S719 | ∞ | 0.50 | 1.52 | 64.00 | | CG7 |
| S720 | ∞ | 0.10 | | | | |

In the seventh embodiment, the conic constant k and the aspheric coefficients A, B, C, D, E, F of each aspheric lens are shown in Table 20.

TABLE 20

| Surface | | | | | | | |
|---|---|---|---|---|---|---|---|
| Number | k | A | B | C | D | E | F |
| S75 | −3.6436 | −2.13E−02 | 2.17E−03 | 1.12E−04 | 0 | 0 | 0 |
| S76 | 0 | −1.05E−02 | −1.28E−03 | 1.83E−03 | 0 | 0 | 0 |
| S77 | 0 | −1.72E−03 | −2.26E−03 | 9.99E−04 | 0 | 0 | 0 |
| S78 | −47.5795 | −1.11E−02 | 3.14E−03 | −4.28E−04 | 0 | 0 | 0 |
| S715 | −0.6729 | −3.61E−03 | 3.04E−04 | −9.47E−06 | 2.09E−07 | −2.75E−07 | 3.48E−09 |
| S716 | −6.4778 | 3.87E−03 | −7.45E−05 | 3.39E−05 | 1.81E−06 | −1.36E−06 | 7.85E−08 |

Table 21 shows the parameters and condition values for conditions (1)-(15) in accordance with the seventh embodiment of the invention. It can be seen from Table 21 that the wide-angle lens assembly 7 of the seventh embodiment satisfies the conditions (1)-(15).

TABLE 21

| | | | | | |
|---|---|---|---|---|---|
| BFL | 2.51 mm | T5 | 1.80 mm | T7 | 0.50 mm |
| d45 | 0.29 mm | | | | |
| \|f2/f\| | 2.90 | \|f4/f\| | 4.68 | \|f5/f\| | 2.97 |
| \|f8/f\| | 3.04 | (R51 − R52)/T5 | 7.92 | (R71 − R72)/T7 | −33.47 |
| f1/f | −3.78 | HFOV/f | 116.96 degrees/ | HFOV/f3 | −33.45 degrees/ |
| | | | mm | | mm |
| HFOV/f4 | 25.00 degrees/ | HFOV/f5 | 39.32 degrees/ | HFOV/f7 | −62.09 degrees/ |
| | mm | | mm | | mm |
| HFOV/f8 | 38.43 degrees/ | TTL/d45 | 60.55 | TTL/BFL | 6.97 |
| | mm | | | | |

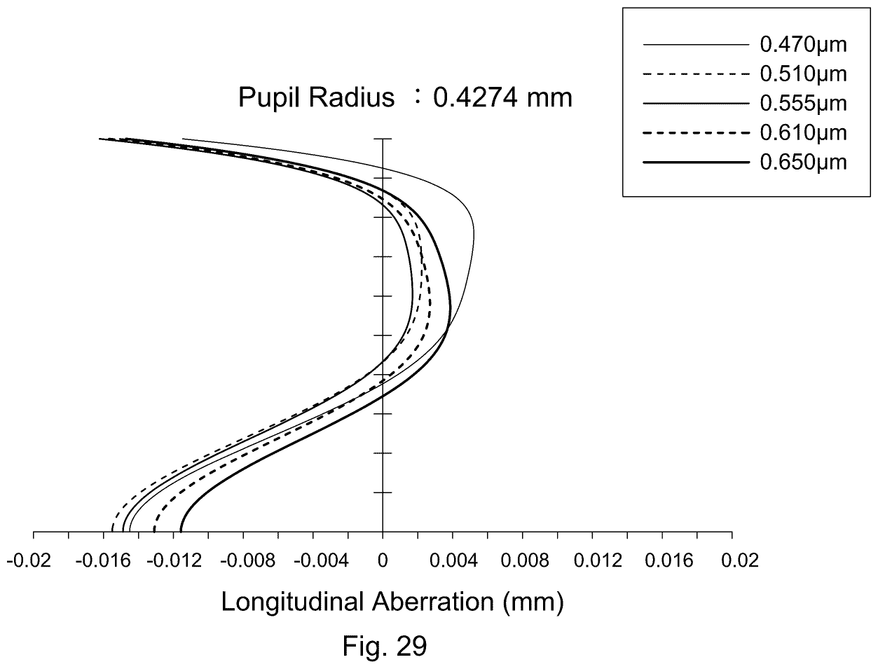

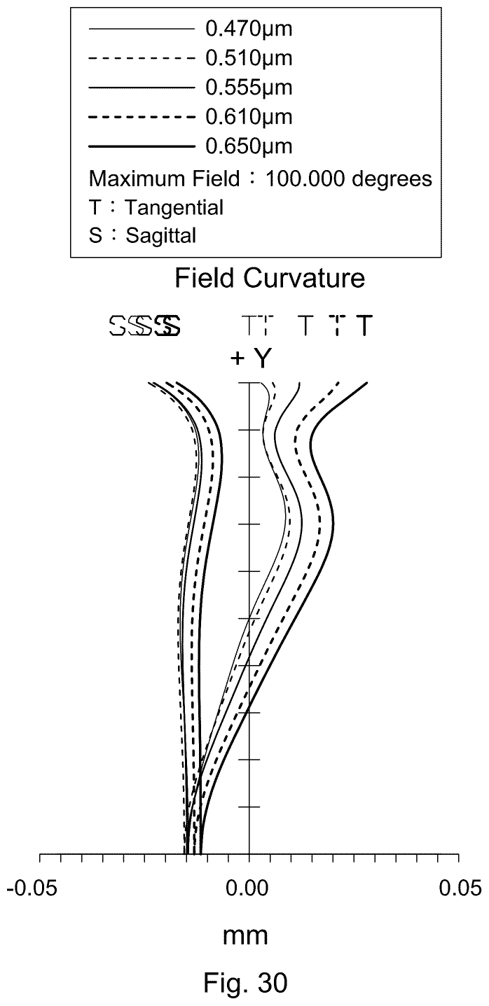

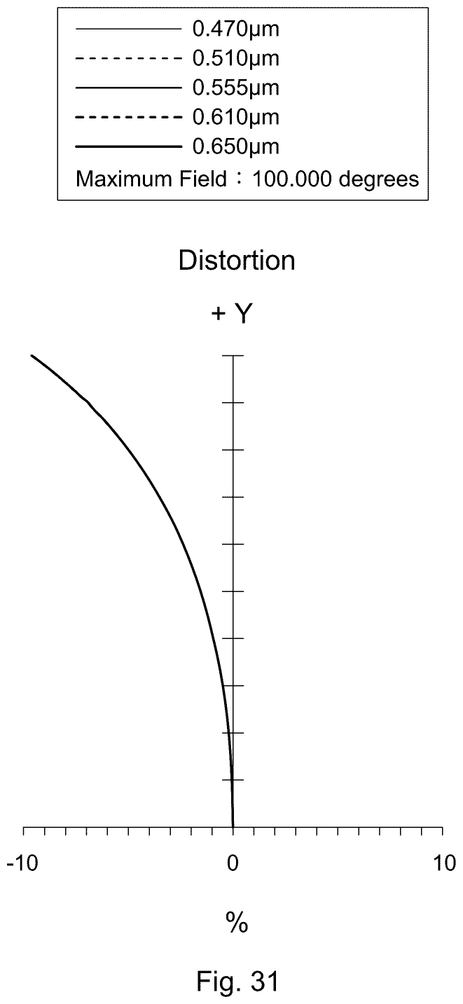

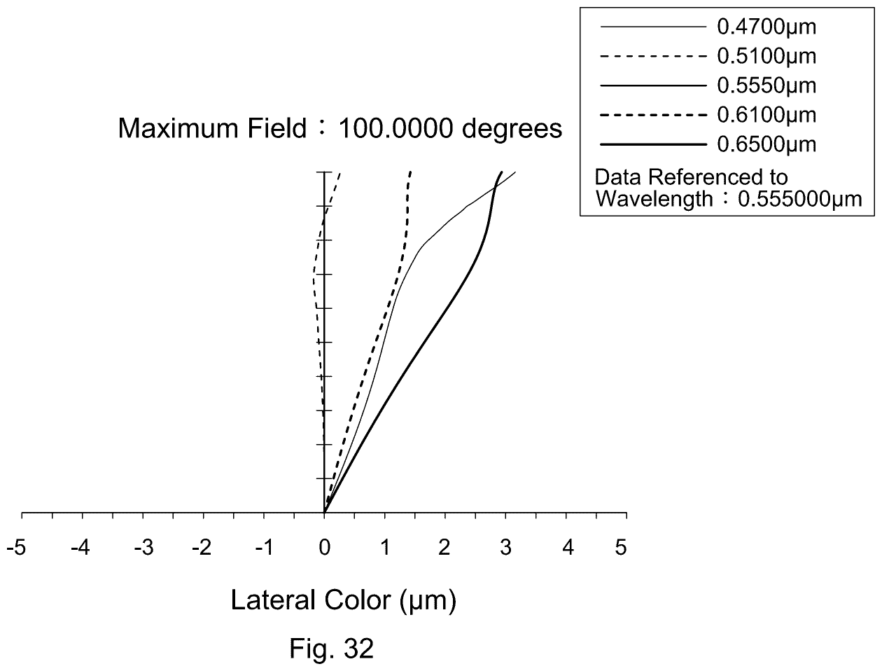

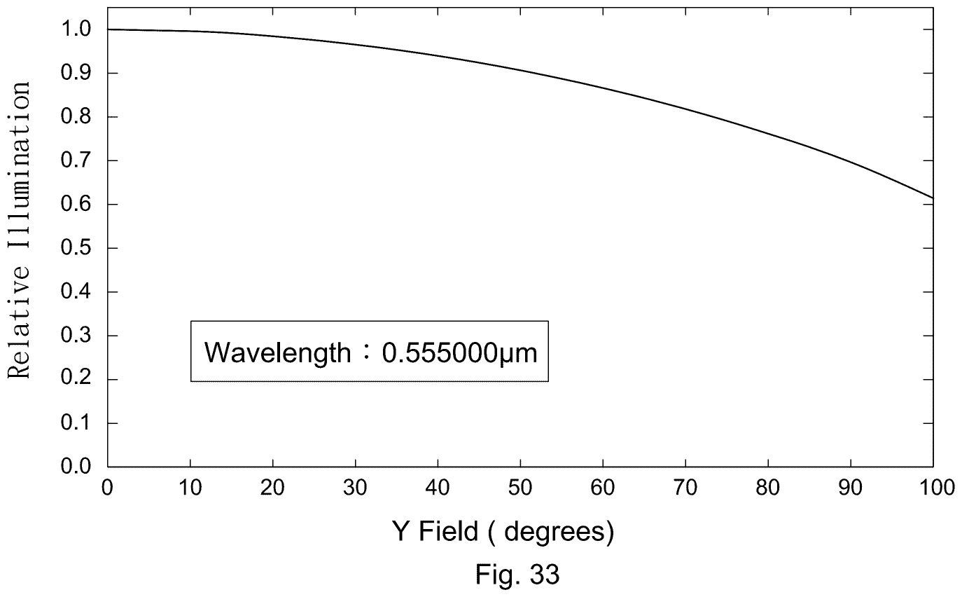

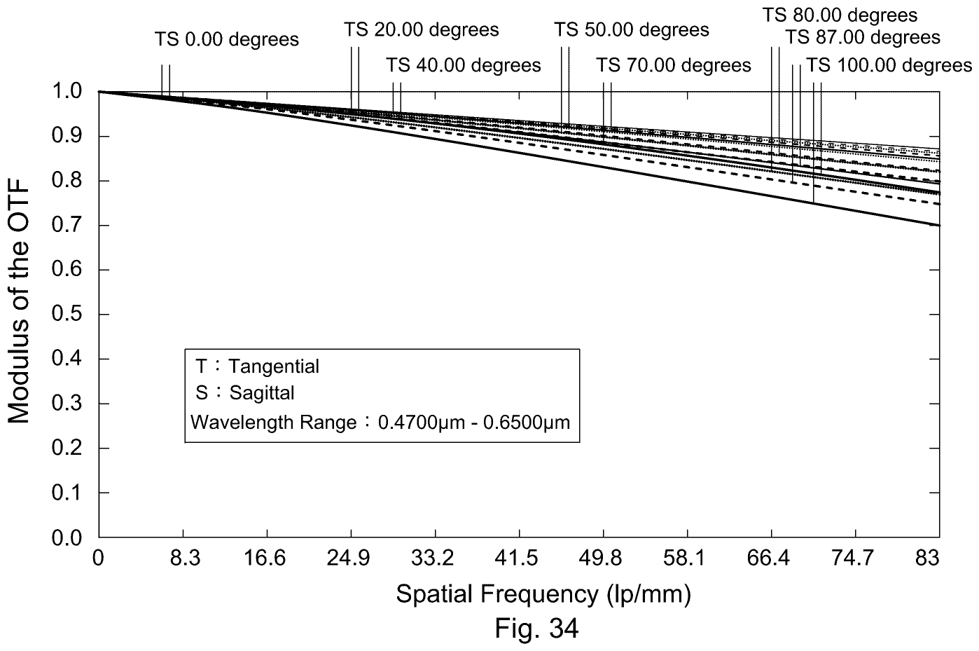

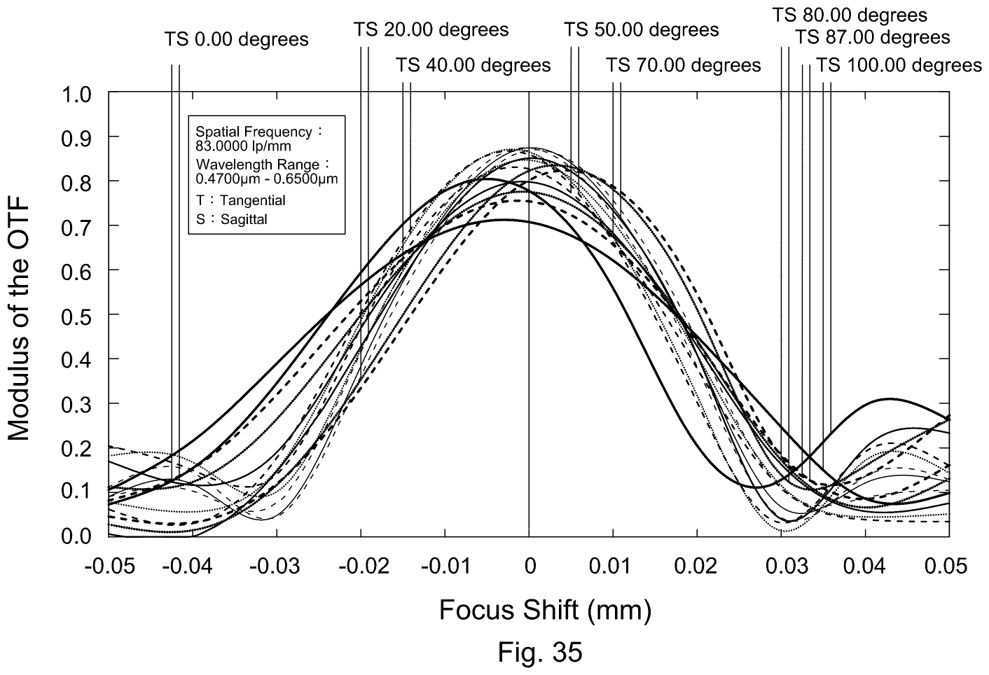

In addition, the wide-angle lens assembly 7 of the seventh embodiment can meet the requirements of optical performance as seen in FIGS. 29-35. It can be seen from FIG. 29 that the longitudinal aberration in the wide-angle lens assembly 7 of the seventh embodiment ranges from −0.017 mm to 0.006 mm. It can be seen from FIG. 30 that the field curvature of tangential direction and sagittal direction in the wide-angle lens assembly 7 of the seventh embodiment ranges from −0.025 mm to 0.03 mm. It can be seen from FIG. 31 that the distortion in the wide-angle lens assembly 7 of the seventh embodiment ranges from −10% to 0%. It can be seen from FIG. 32 that the lateral color in the wide-angle lens assembly 7 of the seventh embodiment ranges from −0.25 μm to 3.25 μm. It can be seen from FIG. 33 that the relative illumination in the wide-angle lens assembly 7 of the seventh embodiment ranges from 0.62 to 1.0. It can be seen from FIG. 34 that the modulation transfer function of tangential direction and sagittal direction in the wide-angle lens assembly 7 of the seventh embodiment ranges from 0.70 to 1.0. It can be seen from FIG. 35 that the through focus modulation transfer function of tangential direction and sagittal direction in the wide-angle lens assembly 7 of the seventh embodiment ranges from 0.0 to 0.88 as focus shift ranges from −0.05 mm to 0.05 mm. It is obvious that the longitudinal aberration, the field curvature, the distortion, the lateral color, and the relative illumination of the wide-angle lens assembly 7 of the seventh embodiment can be corrected effectively, and the resolution and the depth of focus of the wide-angle lens assembly 7 of the seventh embodiment can meet the requirement. Therefore, the wide-angle lens assembly 7 of the seventh embodiment is capable of good optical performance.

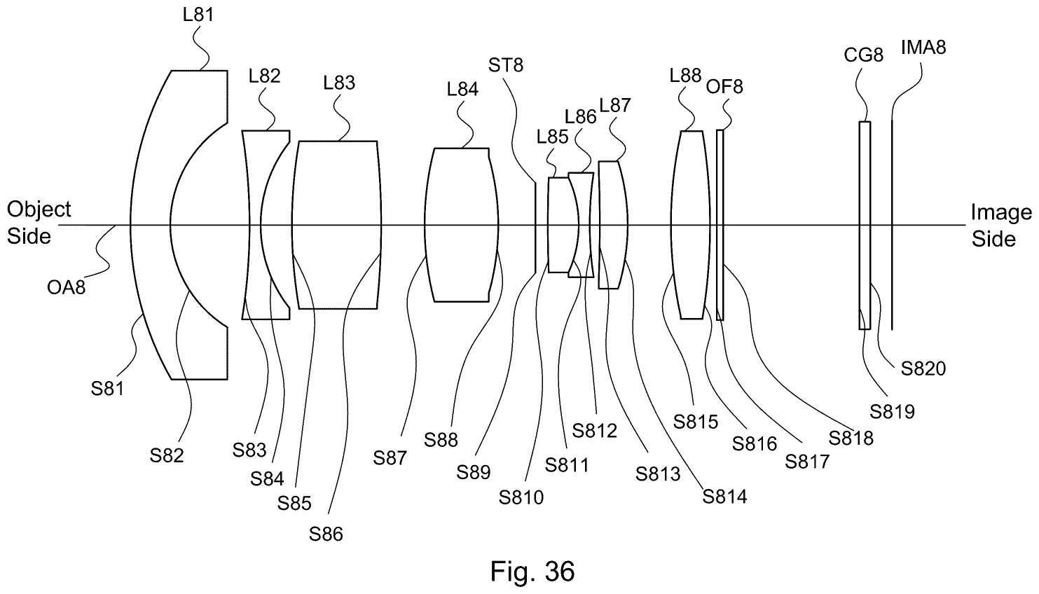

A detailed description of a wide-angle lens assembly in accordance with an eighth embodiment of the invention is as follows. Referring to FIG. 36, the wide-angle lens assembly 8 includes a first lens L81, a second lens L82, a third lens L83, a fourth lens L84, a stop ST8, a fifth lens L85, a sixth lens L86, a seventh lens L87, an eighth lens L88, an optical filter OF8, and a cover glass CG8, all of which are arranged in order from an object side to an image side along an optical axis OA8. In operation, the light from the object side is imaged on an image plane IMA8.

According to the foregoing, wherein: the second lens L82 is a biconcave lens, wherein the object side surface S83 is a concave surface and the image side surface S84 is a concave surface; the third lens L83 is a biconvex lens with positive refractive power, wherein the object side surface S85 is a convex surface, the image side surface S86 is a convex surface, and both of the object side surface S85 and image side surface S86 are spherical surfaces; both of the object side surface S87 and image side surface S88 of the fourth lens L84 are spherical surfaces; both of the object side surface S810 and image side surface S811 of the fifth lens L85 are spherical surfaces; the sixth lens L86 is a biconcave lens with negative refractive power, wherein the object side surface S811 is a concave surface and the image side surface S812 is a concave surface; the fifth lens L85 and the sixth lens L86 are cemented with no air gap between them; the seventh lens L87 is a meniscus lens with positive refractive power, wherein the object side surface S813 is a concave surface and the image side surface S814 is a convex surface; both of the object side surface S815 and image side surface S816 of the eighth lens L88 are spherical surfaces; both of the object side surface S817 and image side surface S818 of the optical filter OF8 are plane surfaces; both of the object side surface S819 and image side surface S820 of the cover glass CG8 are plane surfaces; and with the above design of the lenses, stop ST8, and at least one of the conditions (1)-(15) satisfied, the wide-angle lens assembly 8 can have an effective increased field of view, an effective increased resolution, an effective resisted environment temperature change, and an effective corrected aberration. When the wide-angle lens assembly of the present invention only satisfies condition (12) or condition (13); and the refractive surface shape in independent claim; the basic operation requirements can be met.

Table 22 shows the optical specification of the wide-angle lens assembly 8 in FIG. 36.

TABLE 22
Effective Focal Length = 4.90 mm F-number = 2.64
Total Lens Length = 35.00 mm Field of View = 111.00 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S81 | 14.27 | 1.83 | 1.90 | 31.32 | −10.97 | L81 |
| S82 | 5.51 | 3.66 | | | | |
| S83 | −27.01 | 0.50 | 1.59 | 61.14 | −8.42 | L82 |
| S84 | 6.14 | 1.45 | | | | |
| S85 | 23.15 | 4.09 | 1.92 | 20.88 | 15.56 | L83 |
| S86 | −35.36 | 2.00 | | | | |
| S87 | 14.29 | 3.38 | 1.72 | 47.93 | 9.36 | L84 |
| S88 | −11.48 | 1.71 | | | | |
| S89 | ∞ | 0.57 | | | | ST8 |
| S810 | 55.84 | 1.42 | 1.50 | 81.61 | 9.66 | L85 |
| S811 | −5.22 | 0.50 | 1.85 | 23.78 | −4.59 | L86 |
| S812 | 16.27 | 0.46 | | | | |
| S813 | −73.03 | 1.29 | 1.84 | 42.71 | 13.38 | L87 |
| S814 | −9.80 | 1.99 | | | | |
| S815 | 19.84 | 1.80 | 1.84 | 42.71 | 13.67 | L88 |
| S816 | −26.03 | 0.30 | | | | |
| S817 | ∞ | 0.30 | 1.52 | 64.00 | | OF8 |
| S818 | ∞ | 6.26 | | | | |
| S819 | ∞ | 0.50 | 1.52 | 64.00 | | CG8 |
| S820 | ∞ | 1.00 | | | | |

Table 23 shows the parameters and condition values for conditions (1)-(15) in accordance with the eighth embodiment of the invention. It can be seen from Table 23 that the wide-angle lens assembly 8 of the eighth embodiment satisfies the conditions (1)-(15).

TABLE 23

| | | | | | |
|---|---|---|---|---|---|
| BFL | 8.36 mm | T5 | 1.42 mm | T7 | 1.29 mm |
| d45 | 2.28 mm | | | | |
| \|f2/f\| | 1.72 | \|f4/f\| | 1.91 | \|f5/f\| | 1.97 |
| \|f8/f\| | 2.79 | (R51 − R52)/T5 | 42.96 | (R71 − R72)/T7 | −49.08 |
| f1/f | −2.24 | HFOV/f | 22.65 degrees/ | HFOV/f3 | 7.14 degrees/ |
| | | | mm | | mm |
| HFOV/f4 | 11.86 degrees/ | HFOV/f5 | 11.49 degrees/ | HFOV/f7 | 8.30 degrees/ |
| | mm | | mm | | mm |
| HFOV/f8 | 8.12 degrees/ | TTL/d45 | 15.36 | TTL/BFL | 4.19 |
| | mm | | | | |

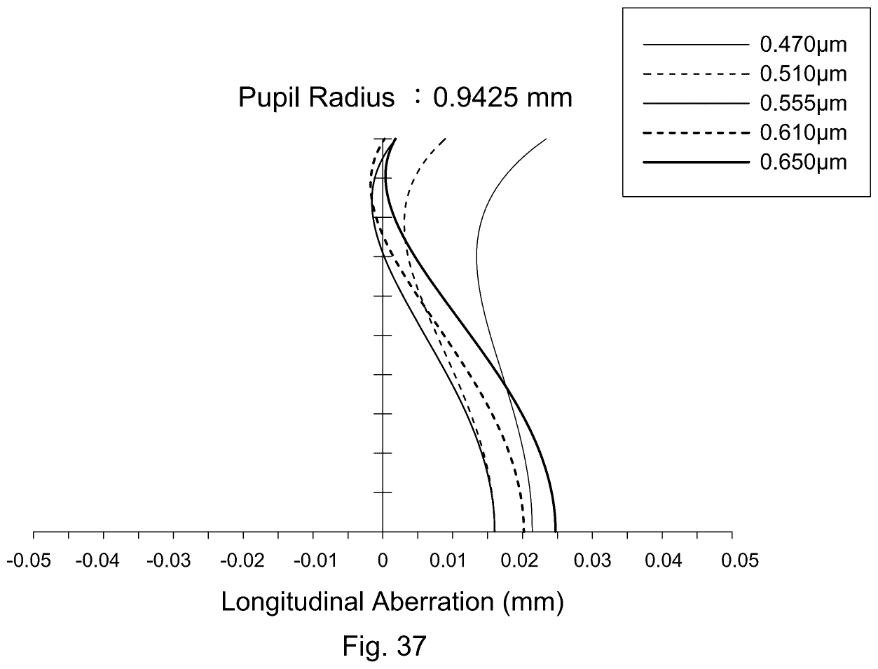

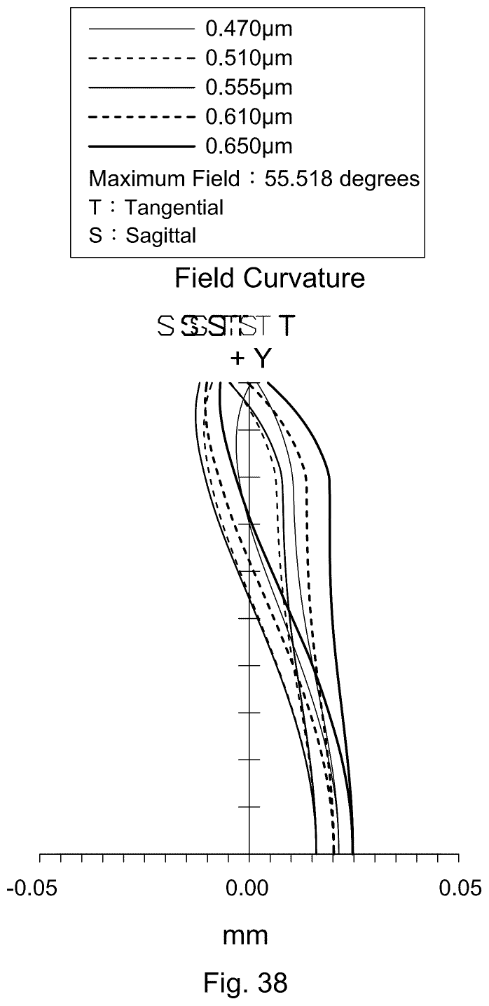

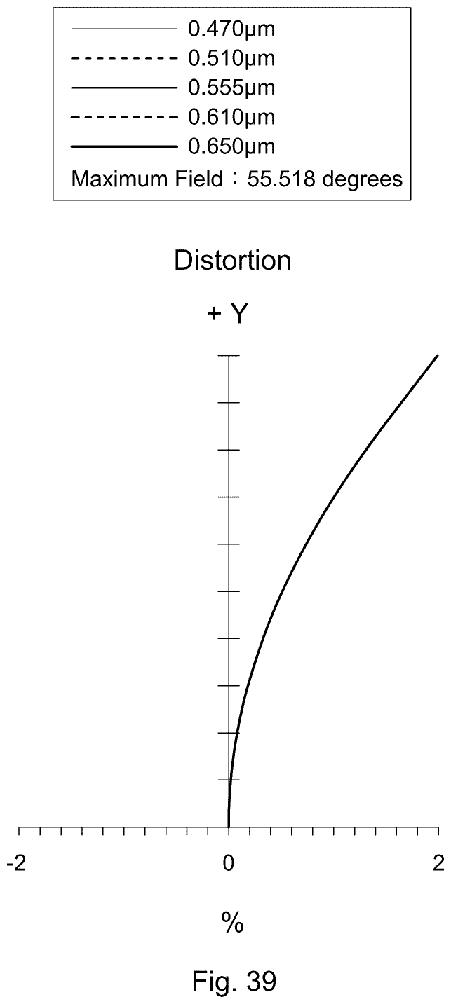

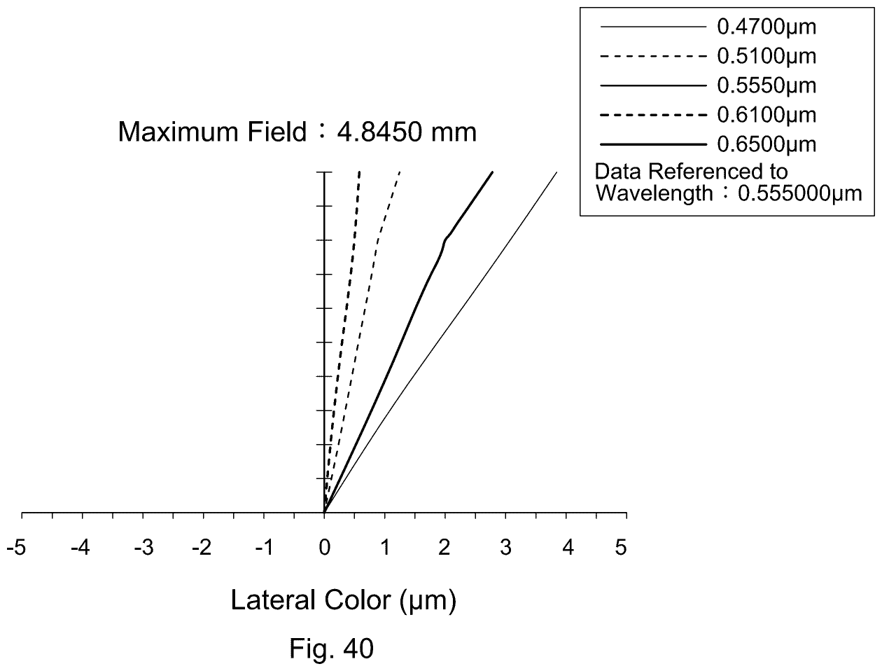

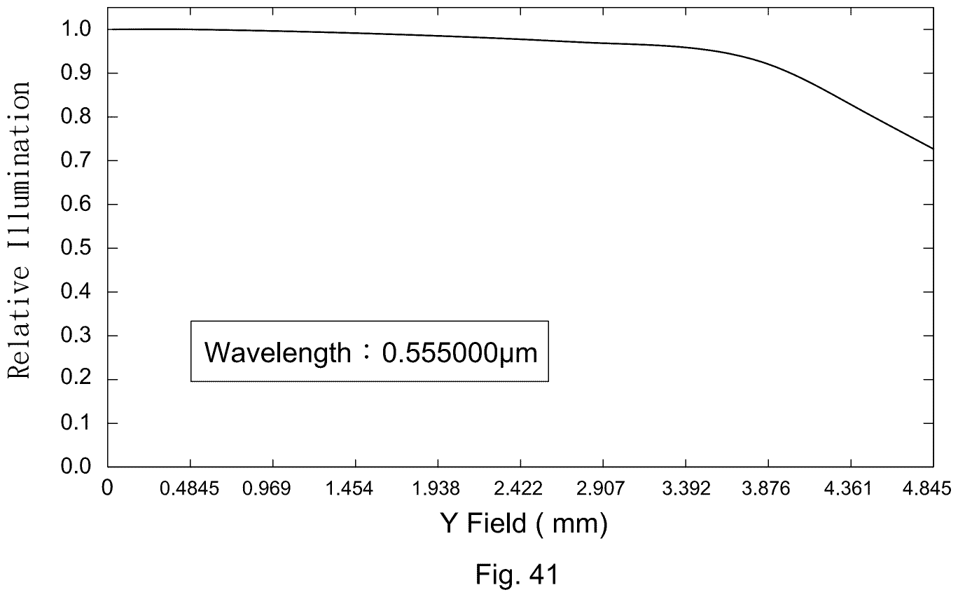

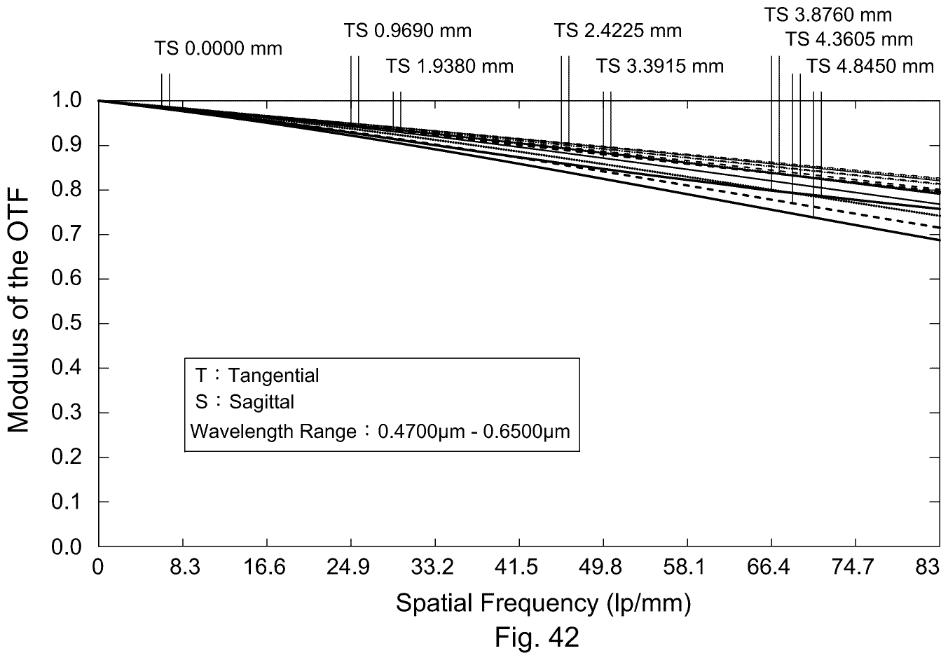

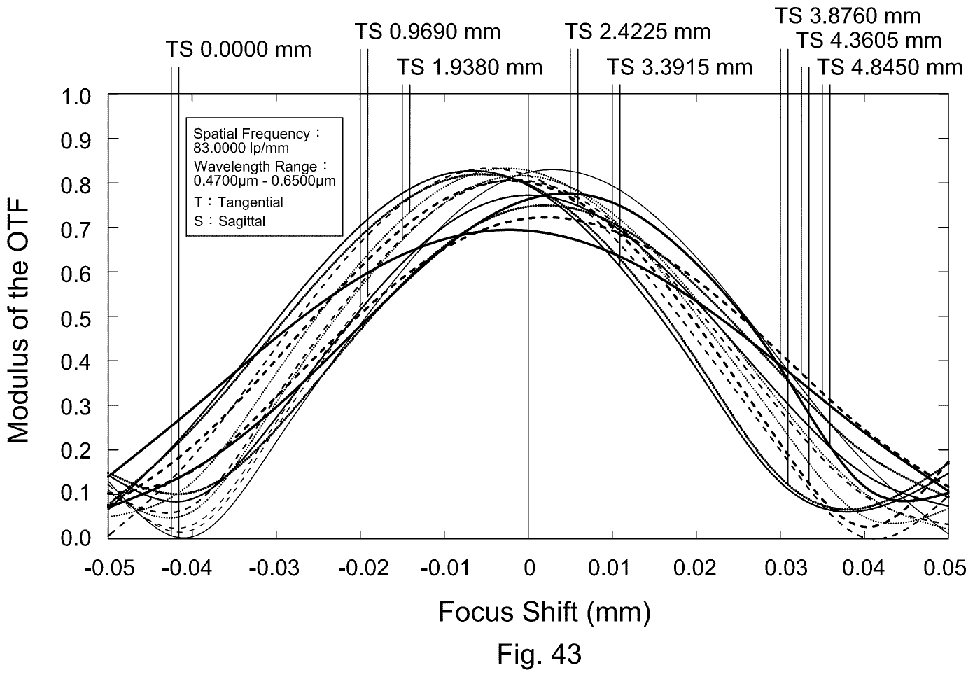

In addition, the wide-angle lens assembly 8 of the eighth embodiment can meet the requirements of optical performance as seen in FIGS. 37-43. It can be seen from FIG. 37 that the longitudinal aberration in the wide-angle lens assembly 8 of the eighth embodiment ranges from −0.005 mm to 0.025 mm. It can be seen from FIG. 38 that the field curvature of tangential direction and sagittal direction in the wide-angle lens assembly 8 of the eighth embodiment ranges from −0.015 mm to 0.025 mm. It can be seen from FIG. 39 that the distortion in the wide-angle lens assembly 8 of the eighth embodiment ranges from 0% to 2%. It can be seen from FIG. 40 that the lateral color in the wide-angle lens assembly 8 of the eighth embodiment ranges from 0 μm to 4 μm. It can be seen from FIG. 41 that the relative illumination in the wide-angle lens assembly 8 of the eighth embodiment ranges from 0.73 to 1.0. It can be seen from FIG. 42 that the modulation transfer function of tangential direction and sagittal direction in the wide-angle lens assembly 8 of the eighth embodiment ranges from 0.69 to 1.0. It can be seen from FIG. 43 that the through focus modulation transfer function of tangential direction and sagittal direction in the wide-angle lens assembly 8 of the eighth embodiment ranges from 0.0 to 0.83 as focus shift ranges from −0.05 mm to 0.05 mm. It is obvious that the longitudinal aberration, the field curvature, the distortion, the lateral color, and the relative illumination of the wide-angle lens assembly 8 of the eighth embodiment can be corrected effectively, and the resolution and the depth of focus of the wide-angle lens assembly 8 of the eighth embodiment can meet the requirement. Therefore, the wide-angle lens assembly 8 of the eighth embodiment is capable of good optical performance.

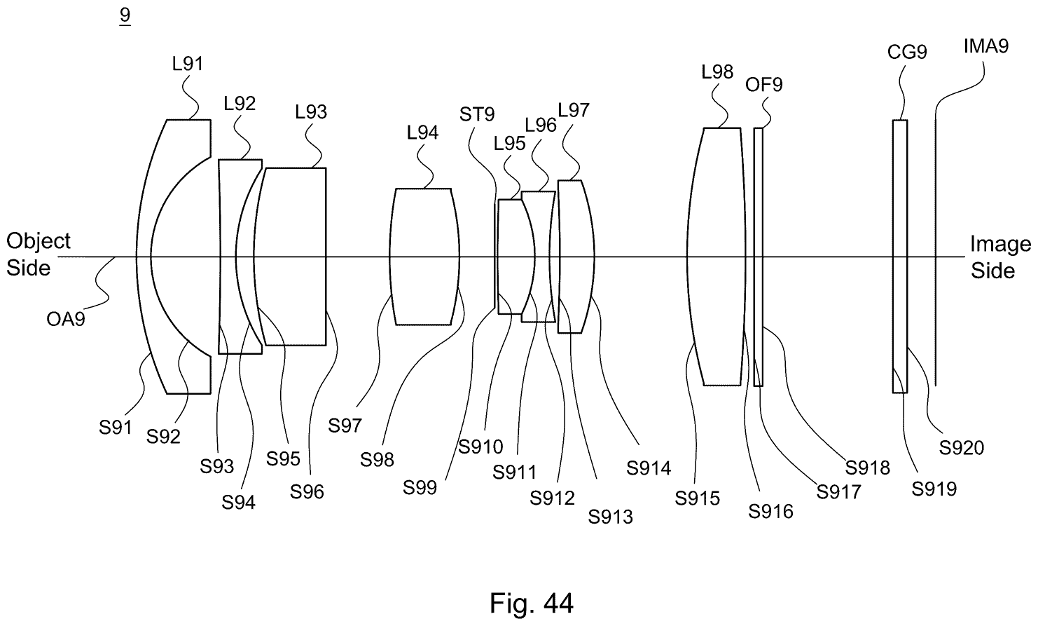

A detailed description of a wide-angle lens assembly in accordance with a ninth embodiment of the invention is as follows. Referring to FIG. 44, the wide-angle lens assembly 9 includes a first lens L91, a second lens L92, a third lens L93, a fourth lens L94, a stop ST9, a fifth lens L95, a sixth lens L96, a seventh lens L97, an eighth lens L98, an optical filter OF9, and a cover glass CG9, all of which are arranged in order from an object side to an image side along an optical axis OA9. In operation, the light from the object side is imaged on an image plane IMA9.

According to the foregoing, wherein: the second lens L92 is a biconcave lens, wherein the object side surface S93 is a concave surface and the image side surface S94 is a concave surface; the third lens L93 is a biconvex lens with positive refractive power, wherein the object side surface S95 is a convex surface, the image side surface S96 is a convex surface, and both of the object side surface S95 and image side surface S96 are spherical surfaces; both of the object side surface S97 and image side surface S98 of the fourth lens L94 are spherical surfaces; both of the object side surface S910 and image side surface S911 of the fifth lens L95 are spherical surfaces; the sixth lens L96 is a biconcave lens with negative refractive power, wherein the object side surface S911 is a concave surface and the image side surface S912 is a concave surface; the fifth lens L95 and the sixth lens L96 are cemented with no air gap between them; the seventh lens L97 is a meniscus lens with positive refractive power, wherein the object side surface S913 is a concave surface and the image side surface S914 is a convex surface; both of the object side surface S915 and image side surface S916 of the eighth lens L98 are spherical surfaces; both of the object side surface S917 and image side surface S918 of the optical filter OF9 are plane surfaces; both of the object side surface S919 and image side surface S920 of the cover glass CG9 are plane surfaces; and with the above design of the lenses, stop ST9, and at least one of the conditions (1)-(15) satisfied, the wide-angle lens assembly 9 can have an effective increased field of view, an effective increased resolution, an effective resisted environment temperature change, and an effective corrected aberration. When the wide-angle lens assembly of the present invention only satisfies condition (14) or condition (15); and the refractive surface shape in independent claim; the basic operation requirements can be met.

Table 24 shows the optical specification of the wide-angle lens assembly 9 in FIG. 44.

TABLE 24
Effective Focal Length = 4.90 mm F-number = 2.64
Total Lens Length = 28.00 mm Field of View = 110.90 degrees

| | Radius of | | | | | |
|---|---|---|---|---|---|---|
| Surface | Curvature | Thickness | | | Effective Focal | |
| Number | (mm) | (mm) | Nd | Vd | Length (mm) | Remark |
| S91 | 11.58 | 0.50 | 1.88 | 40.77 | −7.13 | L91 |
| S92 | 4.01 | 2.43 | | | | |
| S93 | −98.89 | 0.54 | 1.59 | 61.14 | −9.17 | L92 |
| S94 | 5.74 | 0.64 | | | | |
| S95 | 11.74 | 2.53 | 1.92 | 20.88 | 12.38 | L93 |
| S96 | −571.57 | 2.23 | | | | |
| S97 | 13.28 | 2.44 | 1.84 | 47.71 | 6.82 | L94 |
| S98 | −9.20 | 1.23 | | | | |
| S99 | ∞ | 0.10 | | | | ST9 |
| S910 | 46.20 | 1.32 | 1.50 | 81.61 | 8.35 | L95 |
| S911 | −4.53 | 0.50 | 1.85 | 23.78 | −3.89 | L96 |
| S912 | 13.04 | 0.36 | | | | |
| S913 | −50.53 | 1.21 | 1.88 | 40.77 | 10.73 | L97 |
| S914 | −8.10 | 3.26 | | | | |
| S915 | 17.40 | 2.04 | 1.88 | 40.77 | 15.17 | L98 |
| S916 | −56.07 | 0.30 | | | | |
| S917 | ∞ | 0.30 | 1.52 | 64.00 | | OF9 |
| S918 | ∞ | 4.56 | | | | |
| S919 | ∞ | 0.50 | 1.52 | 64.00 | | CG9 |
| S920 | ∞ | 1.00 | | | | |

Table 25 shows the parameters and condition values for conditions (1)-(15) in accordance with the ninth embodiment of the invention. It can be seen from Table that the wide-angle lens assembly 9 of the ninth embodiment satisfies the conditions (1)-(15).

TABLE 25

| | | | | | |
|---|---|---|---|---|---|
| BFL | 6.66 mm | T5 | 1.32 mm | T7 | 1.21 mm |
| d45 | 1.33 mm | | | | |
| \|f2/f\| | 1.87 | \|f4/f\| | 1.39 | \|f5/f\| | 1.70 |
| \|f8/f\| | 3.10 | (R51 − R52)/T5 | 38.36 | (R71 − R72)/T7 | −35.05 |
| f1/f | −1.46 | HFOV/f | 22.63 degrees/ | HFOV/f3 | 8.96 degrees/ |
| | | | mm | | mm |
| HFOV/f4 | 16.26 degrees/ | HFOV/f5 | 13.29 degrees/ | HFOV/f7 | 10.33 degrees/ |
| | mm | | mm | | mm |
| HFOV/f8 | 7.31 degrees/ | TTL/d45 | 20.98 | TTL/BFL | 4.20 |
| | mm | | | | |

While the invention has been described by way of example and in terms of the preferred embodiment(s), it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A wide-angle lens assembly comprising:
a first lens which is with negative refractive power and comprises a concave surface facing an image side;
a second lens which is with refractive power;
a third lens which is with refractive power;
a fourth lens which is with positive refractive power and comprises a convex surface facing the image side;
a fifth lens which is with positive refractive power;
a sixth lens which is with refractive power;
a seventh lens which is with refractive power; and
an eighth lens which is with positive refractive power and comprises a convex surface facing an object side;
wherein the first lens, the second lens, the third lens, the fourth lens, the fifth lens, the sixth lens, the seventh lens, and the eighth lens are arranged in order from the object side to the image side along an optical axis;
wherein the wide-angle lens assembly satisfies at least one of following conditions:
$$4.86 \leq ( R 51 - R 52 ) / T 5 \leq 44.77 ;$$
$$- 55.77 \leq ( R 71 - R 71 ) / T 7 \leq 91.31 ;$$
wherein R51 is a radius of curvature of an object side surface of the fifth lens, R52 is a radius of curvature of an image side surface of the fifth lens, R71 is a radius of curvature of an object side surface of the seventh lens, R72 is a radius of curvature of an image side surface of the seventh lens, T5 is an interval from the object side surface of the fifth lens to the image side surface of the fifth lens along the optical axis, and T7 is an interval from the object side surface of the seventh lens to the image side surface of the seventh lens along the optical axis;
wherein the wide-angle lens assembly further satisfies at least one of following conditions:
$$- 6.85 \leq f 1 / f \leq - 1.21 ;$$
$$17.91 degrees / mm \leq HFOV / f \leq 121.68 degrees / mm ;$$
$$- 35.56 degrees / mm \leq HFOV / f 3 \leq 11.08 degrees / mm ;$$
$$3.47 degrees / mm \leq HFOV / f 4 \leq 29.94 degrees / mm ;$$
$$6.01 degrees / mm \leq HFOV / f 5 \leq 40.87 degrees / mm ;$$
$$- 66.89 degrees / mm \leq HFOV / f 7 \leq 38.23 degrees / mm ;$$
$$1.68 degrees / mm \leq HFOV / f 8 \leq 40.21 degrees / mm ;$$
$$5.32 \leq TTL / d 45 \leq 63.18 ;$$
$$3.69 \leq TTL / BFL \leq 7.13 ;$$
wherein f is an effective focal length of the wide-angle lens assembly, f1 is an effective focal length of the first lens, f3 is an effective focal length of the third lens, f4 is an effective focal length of the fourth lens, f5 is an effective focal length of the fifth lens, f7 is an effective focal length of the seventh lens, f8 is an effective focal length of the eighth lens, HFOV is a full horizontal field of view of the wide-angle lens assembly, TTL is an interval from an object side surface of the first lens to an image plane along the optical axis, BFL is an interval from an image side surface of the eighth lens to the image plane along the optical axis, and d45 is an air interval from an image side surface of the fourth lens to the object side surface of the fifth lens along the optical axis.

2. The wide-angle lens assembly as claimed in claim 1, wherein:
the first lens is a meniscus lens and further comprises a convex surface facing the object side;
the second lens is with negative refractive power;
the fourth lens is a biconvex lens and further comprises another convex surface facing the object side;
the fifth lens is a biconvex lens and comprises a convex surface facing the object side and another convex surface facing the image side; and
the eighth lens is a biconvex lens and further comprises another convex surface facing the image side.

3. The wide-angle lens assembly as claimed in claim 2, wherein:
the second lens is a meniscus lens and comprises a convex surface facing the object side and a concave surface facing the image side; and
the third lens is with negative refractive power and comprises a concave surface facing the object side.

4. The wide-angle lens assembly as claimed in claim 3, wherein the sixth lens is with positive refractive power and the seventh lens is with negative refractive power.

5. The wide-angle lens assembly as claimed in claim 4, wherein:
the sixth lens is a biconvex lens and comprises a convex surface facing the object side and another convex surface facing the image side; and
the seventh lens is a biconcave lens and comprises a concave surface facing the object side and another concave surface facing the image side.

6. The wide-angle lens assembly as claimed in claim 5, wherein the wide-angle lens assembly satisfies at least one of following conditions:
$$0.3 \leq \vert f 2 / f \vert \leq 8.5 ;$$
$$0.2 \leq \vert f 4 / f \vert \leq 8.1 ;$$
$$0.3 \leq \vert f 5 / f \vert \leq 5.7 ;$$
$$0.3 \leq \vert f 8 / f \vert \leq 10.2 ;$$
wherein f is the effective focal length of the wide-angle lens assembly, f2 is an effective focal length of the second lens, f4 is the effective focal length of the fourth lens, f5 is the effective focal length of the 10 fifth lens, and f8 is the effective focal length of the eighth lens.

7. The wide-angle lens assembly as claimed in claim 4, wherein:
the sixth lens is a meniscus lens and comprises a convex surface facing the object side and a concave surface facing the image side; and
the seventh lens is a meniscus lens and comprises a convex surface facing the object side and a concave surface facing the image side.

8. The wide-angle lens assembly as claimed in claim 7, wherein the wide-angle lens assembly satisfies at least one of following conditions:
$$0.3 \leq \vert f 2 / f \vert \leq 8.5 ;$$
$$0.2 \leq \vert f 4 / f \vert \leq 8.1 ;$$
$$0.3 \leq \vert f 5 / f \vert \leq 5.7 ;$$
$$0.3 \leq \vert f 8 / f \vert \leq 10.2 ;$$
wherein f is the effective focal length of the wide-angle lens assembly, f2 is an effective focal length of the second lens, f4 is the effective focal length of the fourth lens, f5 is the effective focal length of the fifth lens, and f8 is the effective focal length of the eighth lens.

9. The wide-angle lens assembly as claimed in claim 3, wherein the sixth lens and the seventh lens are cemented.

10. The wide-angle lens assembly as claimed in claim 9, wherein the wide-angle lens assembly satisfies at least one of following conditions:
$$0.3 \leq \vert f 2 / f \vert \leq 8.5 ;$$
$$0.2 \leq \vert f 4 / f \vert \leq 8.1 ;$$
$$0.3 \leq \vert f 5 / f \vert \leq 5.7 ;$$
$$0.3 \leq \vert f 8 / f \vert \leq 10.2 ;$$
wherein f is the effective focal length of the wide-angle lens assembly, f2 is an effective focal length of the second lens, f4 is the effective focal length of the fourth lens, f5 is the effective focal length of the fifth lens, and f8 is the effective focal length of the eighth lens.

11. The wide-angle lens assembly as claimed in claim 2, wherein the third lens comprises a convex surface or a concave surface facing the image side.

12. The wide-angle lens assembly as claimed in claim 11, wherein the seventh lens is a biconvex lens with positive refractive power and comprises a convex surface facing the object side and another convex surface facing the image side, or the sixth lens and the seventh lens are cemented.

13. The wide-angle lens assembly as claimed in claim 12, wherein:
the second lens is a meniscus lens and comprises a concave surface facing the object side and a convex surface facing the image side;
the third lens is a meniscus lens with positive refractive power and further comprises a convex surface facing the object side; and
the sixth lens is a meniscus lens with negative refractive power and comprises a convex surface facing the object side and a concave surface facing the image side.

14. The wide-angle lens assembly as claimed in claim 13, wherein the wide-angle lens assembly satisfies at least one of following conditions:
$$0.3 \leq \vert f 2 / f \vert \leq 8.5 ;$$
$$0.2 \leq \vert f 4 / f \vert \leq 8.1 ;$$
$$0.3 \leq \vert f 5 / f \vert \leq 5.7 ;$$
$$0.3 \leq \vert f 8 / f \vert \leq 10.2 ;$$
wherein f is the effective focal length of the wide-angle lens assembly, f2 is an effective focal length of the second lens, f4 is the effective focal length of the fourth lens, f5 is the effective focal length of the fifth lens, and f8 is the effective focal length of the eighth lens.

15. The wide-angle lens assembly as claimed in claim 11, wherein:
the second lens is a biconcave lens and comprises a concave surface facing the object side and another concave surface facing the image side;
the third lens is a biconvex lens with positive refractive power and further comprises another convex surface facing the object side;
the seventh lens is a meniscus lens with positive refractive power and comprises a concave surface facing the object side and a convex surface facing the image side; and
the fifth lens and the sixth lens are cemented.

16. The wide-angle lens assembly as claimed in claim 15, wherein the wide-angle lens assembly satisfies at least one of following conditions:
$$0.3 \leq \vert f 2 / f \vert \leq 8.5 ;$$
$$0.2 \leq \vert f 4 / f \vert \leq 8.1 ;$$
$$0.3 \leq \vert f 5 / f \vert \leq 5.7 ;$$
$$0.3 \leq \vert f 8 / f \vert \leq 10.2 ;$$
wherein f is the effective focal length of the wide-angle lens assembly, f2 is an effective focal length of the second lens, f4 is the effective focal length of the fourth lens, f5 is the effective focal length of the fifth lens, and f8 is the effective focal length of the eighth lens.

17. The wide-angle lens assembly as claimed in claim 2, wherein the sixth lens is a biconcave lens with negative refractive power and comprises a concave surface facing the object side and another concave surface facing the image side.

18. The wide-angle lens assembly as claimed in claim 17, wherein the wide-angle lens assembly satisfies at least one of following conditions:
$$0.3 \leq \vert f 2 / f \vert \leq 8.5 ;$$
$$0.2 \leq \vert f 4 / f \vert \leq 8.1 ;$$
$$0.3 \leq \vert f 5 / f \vert \leq 5.7 ;$$
$$0.3 \leq \vert f 8 / f \vert \leq 10.2 ;$$
wherein f is the effective focal length of the wide-angle lens assembly, f2 is an effective focal length of the second lens, f4 is the effective focal length of the fourth lens, f5 is the effective focal length of the fifth lens, and f8 is the effective focal length of the eighth lens.
